(19) United States
(12) Patent Application Publication
(10) Pub. No.: US 2010/0078269 A1
(43) Pub. Date: Apr. 1, 2010

(54) Disk brake

(75) Inventors: Takahiro Tokunaga, Yamanashi (JP); Shinji Suzuki, Yamanashi (JP); Yoichi Kumemura, Kawasaki (JP)

Correspondence Address: RADER FISHMAN & GRAUER PLLC, LION BUILDING, 1233 20TH STREET N.W., SUITE 501, WASHINGTON, DC, 20036, US

(73) Assignee: Hitachi Automotive Systems, Ltd., Kanagawa (JP)

(21) Appl. No.: 12/585,225

(22) Filed: Sep. 9, 2009

(30) Foreign Application Priority Data
Sep. 30, 2008 (JP) 2008-252912

(51) Int. Cl. F16D 65/14

(52) U.S. Cl. 188/73.46

(57) ABSTRACT

There is provided a disk brake, comprising: a pad supporting member where at least a pair of lining pads is supported, and at least two first installation holes are provided at a mounting portion that is installed to a vehicle; at least two second installation holes provided at a non-rotational portion of the vehicle; and a fixing bolt installed into the first and second installation holes so as to fasten the mounting portion and the non-rotational portion, wherein a reinforcement member is provided with at least two internal thread portions into which the fixing bolt is screwed, the reinforcement member being formed with materials different from the ones of the mounting portion and the non-rotational portion, and the mounting portion and the non-rotational portion are fastened by means of the reinforcement member and the fixing bolt.

### BACKGROUND OF THE INVENTION

1. Field of the Invention

The present invention relates to a disk brake.

2. Description of the Related Art

When a caliper of a disk brake is installed in a knuckle on a vehicle side, there is technique that a tie bar is fastened tight together with the knuckle by means of a fixing bolt. See, for example, Japanese Patent Application Laid-Open No. 2002-161930 (hereinafter referred to as Patent Document 1)

Further, there is also technique that an adapter with an internal thread hole is provided with a caliper, and a fixing bolt is screwed into the internal thread portion of the adapter so as to make the caliper fastened to a vehicle. See, for example, Registered Utility Model No. 3001972 (hereinafter referred to as Patent Document 2).

In a disk brake, it is important that a number of parts be reduced, and related costs be cut down.

### SUMMARY OF THE INVENTION

The present invention has been made in light of the above problem, and it is an object of the present invention to provide a disk brake that is able to reduce both a number of parts and related costs.

In order to achieve the object described above, according to a first aspect of the present invention, there is provided a disk brake, comprising: a pad supporting member where at least a pair of lining pads is supported, and at least two first installation holes are provided at a mounting portion that is installed to a vehicle; at least two second installation holes provided at a non-rotational portion of the vehicle; and a fixing bolt installed into the first and second installation holes so as to fasten the mounting portion and the non-rotational portion, wherein a reinforcement member is provided with at least two internal thread portions into which the fixing bolt is screwed, the reinforcement member being formed with materials different from the ones of the mounting portion and the non-rotational portion, and the mounting portion and the non-rotational portion are fastened by means of the reinforcement member and the fixing bolt.

According to a second aspect of the present invention, there is provided a disk brake, comprising: a pad supporting member where at least a pair of lining pads is supported, at least two first installation holes are provided at a mounting portion that is installed to a vehicle, and at least two of second installation holes are provided at a non-rotational portion of the vehicle wherein the installation portion is fastened to the non-rotational portion by means of a fixing bolt that is screwed into the first and the second installation holes; and a reinforcement member that: is provided at the mounting portion of the pad supporting member; has at least two internal thread portions into which the fixing bolt is screwed; and is formed by metal, Young's modulus of which is higher than the mounting portion of the pad supporting member wherein the reinforcement member is placed on a side opposite to the non-rotational portion and installed to the mounting portion in a condition that the first installation hole and the internal thread hole are positionally coincident to each other.

According to a third aspect of the present invention, there is provided a disk brake, comprising: an aluminum alloy caliper, the caliper being integrally composed of: a pad supporting member where at least a pair of lining pads is supported so as to sandwich a disk, and at least two first installation holes are provided at a mounting portion that is installed to a vehicle; and a cylinder member where pistons are provided facing to each other so as to press each of the lining pads, the caliper being installed to the vehicle by means of a fixing bolt installed into the first installation hole as well as at least two second installation holes provided at a non-rotational portion of the vehicle; a metal-made reinforcement member that is formed with Young's modulus higher than the mounting portion of the caliper and that is composed of: at least two adaptor portions provided on a side opposite to the non-rotational portion, the adaptor portions being fastened to the mounting portion of the pad supporting member and being provided with an internal thread portion into which the fixing bolt is screwed; and a tie bar portion that connects each of the adaptor portions, wherein the reinforcement member is fastened to and supported by the mounting portion of the pad supporting member by means of the adaptor portions.

### BRIEF DESCRIPTION OF THE DRAWINGS

FIG. 1 is a front view of a disk brake according to a first embodiment of the present invention;

FIG. 2 is a cross-sectional view of the disk brake according to the first embodiment of the present invention, which is taken along a line Y1-Y1 as shown in FIG. 1;

FIG. 3 is a cross-sectional view of the disk brake according to the first embodiment of the present invention, which is taken along a line X1-X1 as shown in FIG. 1;

FIG. 4 is a cross-sectional view of a disk brake according to a second embodiment of the present invention, which is taken along a line X1-X1 as shown in FIG. 1;

FIG. 5 is a cross-sectional view of a disk brake according to a third embodiment of the present invention, which is taken along a line X1-X1 as shown in FIG. 1;

FIG. 6 is a cross-sectional view partially enlarging a tie bar of the disk brake according to the third embodiment of the present invention;

FIG. 7 is a cross-sectional view partially enlarging a modified example of the tie bar of the disk brake according to the third embodiment of the present invention;

FIG. 8 is a cross-sectional view of a disk brake according to a fourth embodiment of the present invention, which is taken along a line X1-X1 as shown in FIG. 1;

FIG. 9 is a cross-sectional view of a disk brake according to a fifth embodiment of the present invention, which is taken along a line X1-X1 as shown in FIG. 1;

FIG. 10 is a cross-sectional view of a disk brake according to a sixth embodiment of the present invention, which is taken along a line X1-X1 as shown in FIG. 1;

FIG. 11 is a front view of a disk brake according to a seventh embodiment of the present invention;

FIG. 12 is a cross-sectional view of the disk brake according to the seventh embodiment of the present invention, which is taken along a line Y2-Y2 as shown in FIG. 11;

FIG. 13 is a cross-sectional view of the disk brake according to the seventh embodiment of the present invention, which is taken along a line X2-X2 as shown in FIG. 11;

FIG. 14 is a cross-sectional view of a disk brake according to an eighth embodiment of the present invention, which is taken along a line X2-X2 as shown in FIG. 11;

FIG. 15 is a cross-sectional view of a disk brake according to a ninth embodiment of the present invention, which is taken along a line X2-X2 as shown in FIG. 11;

FIG. 16 is a cross-sectional view of a disk brake according to a tenth embodiment of the present invention, which is taken along a line X2-X2 as shown in FIG. 11;

FIG. 17 is a cross-sectional view of a disk brake according to an eleventh embodiment of the present invention, which is taken along a line X2-X2 as shown in FIG. 11; and

FIG. 18 is a cross-sectional view of a disk brake according to a twelfth embodiment of the present invention, which is taken along a line X2-X2 as shown in FIG. 11.

### DETAILED DESCRIPTION OF THE PREFERRED EMBODIMENTS

Preferred embodiments of the present invention will be described with reference to the accompanying drawings.

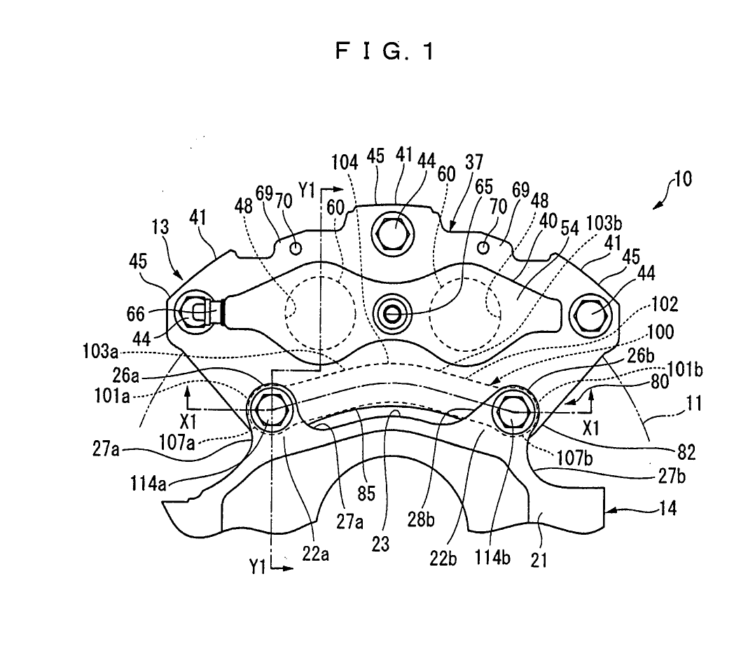

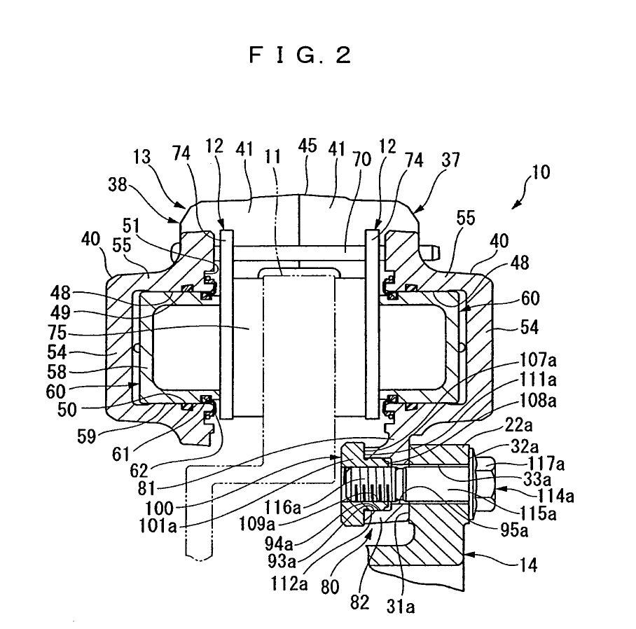

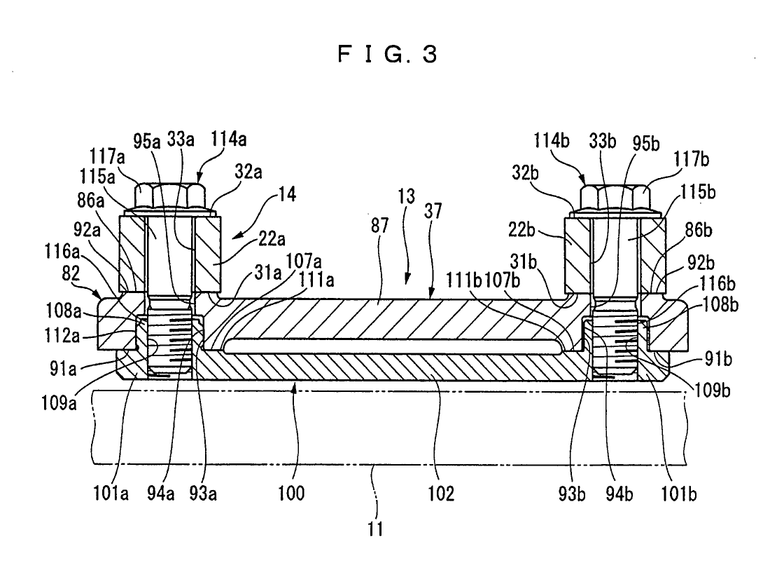

A first embodiment of the present invention will be explained based on FIGS. 1 to 3. FIG. 1 is a front view of a disk brake according to the first embodiment. FIG. 2 is a cross-sectional view of the disk brake according to the first embodiment, taken along a line Y1-Y1 as shown in FIG. 1. FIG. 3 is a cross-sectional view of the disk brake according to the first embodiment, taken along a line X1-X1 as shown in FIG. 1.

As shown in FIGS. 1 and 2, a disk brake 10 according to the first embodiment comprises: a disk 11 integrally rotated with a wheel (not shown); a caliper (a pad supporting member or a cylinder member) 13 supporting two pairs of lining pads 12 (only one pair is shown in FIG. 2) that each sandwich the disk 11 from the both sides thereof; and a knuckle 14 being as a non-rotational portion of a vehicle to which the caliper 13 is attached. This disk brake 10 is for a four-wheeled vehicle and categorized into a type that the caliper 13 is fixed to the knuckle 14.

The knuckle 14 is made of metal such as aluminum alloy, cast iron, etc. and includes: a base portion 21 extending in a direction orthogonal to a disk axis; and a mounting projection 22a and a mounting projection 22b each projecting outward in a radius direction of the disk 11, the mounting projections 22a and 22b being spaced in a circumferential direction of the disk 11. An intermediate surface 23 placed between the mounting projection 22a and the mounting projection 22b of the base portion 21 is formed into a circular arc configuration that projects outward in a radius direction.

Further, the mounting projection 22a (left side in FIG. 1) has a tip side that projects outward in a radius direction of the disk 11 so as to form a projected end surface 26a in a semicircular configuration. Moreover, both base sides of the mounting projection 22a in a circumferential direction are formed into base surfaces 27a, 27a continuously connecting with both the outer edge of the base portion 21 and the projected end surface 26a, the base surfaces 27a, 27a being formed into a circular arc configuration.

Still further, the mounting projection 22b (right side in FIG. 1) has a tip side that projects outward in a radius direction of the disk 11 so as to form a projected end surface 26b in a semicircular configuration. The base side of the mounting projection 22b that is opposite to the mounting projection 22a is formed into a base surface 27b continuously connecting with the outer edge of the base portion 21 and the mounting projection 22b, the base surface 27b being formed into a circular arc configuration. On the other hand, the base side of the mounting projection 22b that faces to the mounting projection 22a is formed as that a linear line starts from the projected end surface 26b and continuously extends to the intermediate surface 23 of the base portion 21 so as to form a base inclined surface 28b. Here, the line starting from the projected end surface 26b gradually deviates from the center of the mounting projection 22b as approaching toward the intermediate surface 23. Accordingly, the mounting projection 22b is formed as that the base thereof is widened in a circumferential direction of the disk 11 compared to the mounting projection 22a.

As shown in FIGS. 2 and 3, the mounting projection 22a includes: a first surface 31a on a side of the disk 11 in a direction orthogonal to a disk axis; a second surface 32a on a side opposite to the disk 11 in a direction orthogonal to the disk axis; and a straight installation hole (second installation hole) 33a penetrated in a direction of the disk axis so as to connect each center of the first surface 31a and the second surface 32a.

As shown in FIG. 3, the mounting projection 22b comprises: a first surface 31b on a side of the disk 11 which is coplanar with the first surface 31a; a second surface 32b on a side opposite to the disk 11 which is coplanar with the second surface 32a; and a straight bolt installation hole (second installation hole) 33b penetrated in a direction of the disk axis so as to connect each center of the first surface 31b and the second surface 32b. The straight installation hole 33a and the straight bolt installation hole 33b each have an identical diameter.

As shown in FIG. 2, the caliper 13 comprises: an inner caliper half body 37 arranged on an inner side of a vehicle in a direction of the disk axis; and an outer caliper half body 38 arranged on an outer side of the vehicle in a direction of the disk axis, the inner caliper half body 37 and the outer caliper half body 38 being faced to each other so as to be integrally connected. The inner caliper half body 37 and the outer caliper half body 38 are each made of aluminum alloy and integrally molded.

The inner caliper half body 37 and the outer caliper half body 38 each comprise cylinder portions 40, 40 on the center side of the disk 11 and connecting projections 41, 41 on a periphery side of the disk 11, the connecting projections 41, 41 each projecting toward the disk 11 compared to the cylinder portions 40, 40. As exemplifying the inner caliper half body 37 in FIG. 1, the inner caliper half body 37 and the outer caliper half body 38 are each provided with 3 connecting projections 41, 41, 41 in a disk circumferential direction.

The inner caliper half body 37 and the outer caliper half body 38 are faced to each other so that the connecting projections 41, 41, 41 are made to be coincident to each other in a disk circumferential direction. The inner caliper half body 37 and the outer caliper half body 38 are then connected with each other by means of tie bolts 44, 44, 44. In the caliper 13, these connecting projections 41, 41, 41 where the inner caliper half body 37 and the outer caliper half body 38 are faced to each other construct disk path portions 45, 45, 45 in which to stride over an outer periphery of the disk 11 in its radius direction. The disk path portions 45, 45, 45 are formed at three portions in a disk circumferential direction.

Each cylinder portion 40 of the inner caliper half body 37 and the outer caliper half body 38 is, as shown in FIG. 2, arranged so as to face the disk 11, the cylinder portion 40 each being provided with a bore 48 opening toward the disk 11. A pair of the bores 48, 48 is coaxially arranged in a direction of the disk axis of the inner caliper half body 37 and the outer caliper half body 38. Here, as shown in FIG. 1 with the inner caliper half body 37, on each of the cylinder portions 40, 40 of the inner cylinder half body 37 and the outer caliper half body 38, there is provided a pair of the bores 48, 48 spaced in a disk circumferential direction. As shown in FIG. 2, each of the bores 48, 48 is provided with a seal circumference groove 49 on the opened side, and a piston seal 50 made of a rubber square ring is fastened to the seal circumference groove 49. Further, a cover groove 51 is formed at an end surface of each of the cylinder portions 40, 40 on a side of the disk 11, the cover groove 51 being formed as to surround each of the bores 48, 48. Still further, each of the cylinder portions 40, 40 comprises: a bottom portion 54 forming a bottom surface of the bore 48 on a side opposite to the disk 11; and a wall portion 55 forming an external diameter side of the bore 48.

At each of the bores 48, 48, a closed-end, cylindrical piston 60 with a base 58 and a cylindrical portion 59 is slidably installed as that the base 58 is placed so as to face the bottom portion 54 of the cylinder portion 40. Accordingly, two pairs of the pistons 60 each coaxially arranged so as to face each other in a direction of the disk axis are provided as being spaced in a disk circumferential direction. That is, the caliper 13 is categorized into a two-pot caliper type of an opposed piston type. At an outer periphery of the cylindrical portion 59 of each of the pistons 60 (opened side or disk 11 side), a groove 61 is formed, and a rubber cover 62 is placed between the groove 61 and the cover groove 51 as to externally surround the groove 61. The cover 62 will prevent foreign matters from breaking into clearance between the bore 48 and the piston 60 from the opened side of the bore 48.

As shown in FIG. 1, brake fluid is suppliable to each of the bores 48 from a supply port 65 formed on the bottom portion 54 of the inner caliper half body 37. According to the supply of the brake fluid, two pairs of the pistons 60 are adapted to project in a synchronized manner. In this instance, the piston seal 50 shown in FIG. 2 will seal clearance between the bore 48 and the piston 60 so as to prevent leakage of the brake fluid. Moreover, as shown in FIG. 1, a bleeder 66 is provided at an end portion of the wall portion 55 of the inner caliper half body 37 in a disk circumferential direction.

As shown in FIG. 1 with the inner caliper half body 37, on each of the inner caliper half body 37 and the outer caliper half body 38, there are provided three disk path portions 45, 45, 45 spaced in a disk circumferential direction. Between the disk path portions adjacent to each other, pin installation portions 69, 69 are provided. In a condition where the pin installation portions 69, 69 are coincident to each other in a disk circumferential direction, pad pins 70, 70 are adapted to bridge over in a direction of the disk axis. As shown in FIG. 2 (one side only), each of the pad pins 70, 70 is inserted into a pair of the lining pads 12, 12 sandwiching the disk 11 in its axis direction, whereby each of the lining pads 12, 12 is suspended in which to be able to slide in a direction of the disk axis relative to the caliper 13. In this manner, two pairs of the lining pads are supported by the caliper 13.

Each of the lining pads 12 is composed of a back plate 74 and a friction material 75 attached to the back plate 74, and supported with the pad pin 70 by the back plate 74. Moreover, each of the lining pads 12 is pressed by each of the pistons 60 so that its friction material 75 is adapted to abut against the disk 11.

The inner caliper half body 37 is integrally provided with a vehicle-side mounting portion 80 installed to a vehicle, the vehicle-side mounting portion 80 being placed on the opened side of the cylinder portion 40. This vehicle-side mounting portion 80 comprises: an extended portion 81 slightly extended from the opened side of the cylinder portion 40; and a mounting portion 82 extended from the extended portion 81, the vehicle-side mounting portion 80 being symmetrically formed. The mounting portion 82 is formed so as to project to the disk 11 compared to the extended portion 81 and to be thicker than the extended portion 81 in a direction of the disk axis.

As shown in FIG. 1, a marginal surface 85 of the mounting portion 82 that is placed on rather center side in a disk radius direction is formed into a circular arc that projects outward in a disk radius direction. Further, as shown in FIG. 3, the mounting portion 82 is provided with a pair of a mounting boss portion 86a and a mounting boss portion 86b on both ends in a disk circumferential direction, the mounting boss portion 86a and the mounting boss portion 86b being thicker than other portions so as to project in a direction of the disk axis. Accordingly, the mounting portion 82 is provided with an intermediate connecting portion 87 connecting the mounting boss portion 86a and the mounting boss portion 86b, the intermediate connecting portion 87 being slightly thinner than the mounting boss portion 86a and the mounting boss portion 86b in a direction of the disk axis.

The mounting boss portion 86a placed on one side in a disk circumferential direction is provided with a surface portion 91a on a side of the disk 11 in a direction orthogonal to the disk axis and a surface portion 92a on a side opposite to the disk 11 in a direction orthogonal to the disk 11. An installation hole (a first installation hole) 93a is formed so as to penetrate in a disk axis direction, whereby the surface portions 91a and 92a are connected through their center portions. The installation hole 93a is provided with: a recess 94a on a side of the disk 11 or on a side opposite to the knuckle 14, the recess 94a being formed with a circular cross section having an identical diameter toward the knuckle 14 side; and a penetrated hole 95a on a side of the knuckle 14 in which to penetrate from the center portion of the recess 94a to the knuckle 14 side, the penetrated hole 95a being formed with a circular cross section having an identical diameter but smaller than the one of the recess 94a. Accordingly, the installation hole 93a is formed with steps.

The mounting boss portion 86b on the other side in a disk circumferential direction is formed symmetrically relative to the mounting boss portion 86a. The mounting boss portion 86b is provided with: a surface portion 91b provided on a side of the disk 11, the surface portion 91b being coplanar with the surface portion 91a; and a surface portion 92b on a side opposite to the disk 11, the surface portion 92b being coplanar with the surface portion 92a. An installation hole (a first installation hole) 93b is formed so as to penetrate in a disk axis direction, whereby the surface portions 91b and 92b are connected through their center portions. The installation hole 93b is provided with: a recess 94b on a side of the disk 11 or on a side opposite to the knuckle 14, the recess 94b being formed with a circular cross section having an identical diameter toward the knuckle 14 side; and a penetrated hole 95b on a side of the knuckle 14 in which to penetrate from the center portion of the recess 94b to the knuckle 14 side, the penetrated hole 95b being formed with a circular cross section having an identical diameter but smaller than the one of the recess 94b. Accordingly, the installation hole 93b is formed with steps.

Here, in the first embodiment of the present invention, on a side of the disk 11 or on a side opposite to the knuckle 14, a tie bar (reinforcement member) 100 is arranged at the mounting portion 82 of the caliper 13. This tie bar 100 is made of materials that are different from the aluminum alloy inner caliper half body 37 including the mounting portion 82 as well as the aluminum alloy knuckle 14. That is, the tie bar 100 is integrally molded by materials such as iron (cast iron or steel) which has Young's modulus higher than the mounting portion 82 and the knuckle 14.

The tie bar 100 is, as shown in FIG. 1, formed approximately in a symmetrical manner as that the center portion of the tie bar 100 in a longitudinal direction (the center portion between internal thread portions 109a, 109a later explained) is as the center. Further, the tie bar 100 is formed with a pair of adaptor portions 101a, 101b on the both ends thereof in a disk circumferential direction, and formed with a tie-bar portion 102 between the adaptor portion 101a and the adaptor portion 101b as to connect those adaptor portions to each other. The tie-bar portion 102 includes a pair of linear side portions 103a, 103b which has the same length, the side portions 103a, 103b being connected to each other with a curved intermediate portion 104. That is, the tie-bar portion 102 is formed in a symmetrical manner and curved with an obtuse angle as a whole. Further, the tie-bar portion 102 is arranged along the circular-arc marginal surface 85 of the mounting portion 82 of the caliper 13. The tie-bar portion has width approximately constant in a disk radius direction and has thickness constant in a disk axis direction as shown in FIG. 3.

The adaptor portion 101a on one side in a disk circumferential direction is thick-walled relative to the tie-bar portion 102 as to slightly project to a side opposite to the disk 11 in a disk axis direction. Further, as shown in FIGS. 1 and 3, the adaptor portion 101a comprises: a circular mounting seat 107a having a diameter larger than the width of the tie-bar portion 102; and a projection portion 108a cylindrically projecting from the center portion of the mounting seat 107a to a side opposite to the disk 11 in a disk axis direction. Furthermore, an internal thread portion 109a is formed so as to penetrate center portions of both the mounting seat 107a and the projection portion 108a in a direction of the disk axis.

The mounting seat 107a is provided with a surface portion 111a on a side that the projection portion 108a is formed or on a side opposite to the disk 11, the surface portion 111a being a surface orthogonal to the disk axis. The projection portion 108a projects from the center portion of the surface portion 111a to a side opposite to the disk 11, that is, in a direction of the disk axis. Here, the projection portion 108a is provided with an annular convex portion 112a where the outer diameter thereof becomes narrower in an axial direction as moving outward in a radius direction, the convex portion 112a being also formed with an outer periphery surface that is a straight configuration.

Compared to the adaptor portion 101a where the projection portion 108 is provided with the convex portion 112a, the adaptor portion 101b on the other side in a disk circumferential direction is formed to be symmetrical with the adaptor portion 101a except the formation of the annular convex portion. The adaptor portion 101b is thick-walled relative to the tie-bar portion 102 as to slightly project to a side opposite to the disk 11 in a disk axis direction. Further, as shown in FIGS. 1 and 3, the adaptor portion 101b comprises: a circular mounting seat 107b having a diameter larger than the width of the tie-bar portion 102; and a projection portion 108b cylindrically projecting from the center portion of the mounting seat 107b to a side opposite to the disk 11 in a disk axis direction. Furthermore, an internal thread portion 109b is formed so as to penetrate center portions of both the mounting seat 107b and the projection portion 108b in a direction of the disk axis.

The mounting seat 107b is provided with a surface portion 111b on a side that the adaptor portion 101b is projected or on a side opposite to the disk 11 so as to be coplanar with the surface portion 111a. The projection portion 108b is formed to project from the center of the surface portion 111b to a side opposite to the disk 11, in a direction of the disk axis.

The outer diameter of the projection portion 108a of the adaptor portion 101a on one side in a disk circumferential direction where the annual convex portion 112a is formed is larger than the one of the projection portion 108b of the adaptor portion 101b on the other side in a disk circumferential direction. Further, the outer diameter of the projection portion 108a is larger than the recess 94a of the mounting portion 82 of the caliper 13 for interference. On the other hand, the outer diameter of the projection portion 108b of the adaptor portion 101b on the other side in a disk circumferential direction is slightly smaller than the recess 94b of the mounting portion 82 of the caliper 13. Further, a center distance of the projection portions 108a, 108b is set to be identical with a center distance of the recesses 94a, 94b.

In this tie bar 100, before the caliper is installed into a vehicle, the tie bar 100 is supported by the caliper 13. In this condition, the projection portions 108a, 108b are fastened to the recesses 94a, 94b of the installation holes 93a, 93b of the caliper 13. Here, the projection portion 108a of the adaptor portion 101a is pressed to the recess 94a so as to fasten to each other while the projection portion 108b of the adaptor portion 101b is loosely fitted to the recess 94b. Since the projection portion 108a of the adaptor portion 101a is press-fitted into the recess 94a, the tie bar 100 is adapted to be supported by the mounting portion 82. Here, in a condition where the tie bar 100 is fastened to and supported by the mounting portion 82 of the caliper 13 by means of the adaptor portion 101a, the surface portion 111a of the mounting seat 107a of the tie bar 100 is adapted to abut to the surface portion 91a of the mounting boss portion 86a of the mounting portion 82 of the caliper 13. Accordingly, the surface portion 111b of the mounting seat 107b is adapted to the surface portion 91b of the mounting boss portion 86b. Further, in this condition, the installation hole 93a of the mounting portion 82 of the caliper 13 and the internal thread portion 109a of the tie bar 100 are coincident to each other, that is, arranged to be coaxial. Still further, the installation hole 93b of the mounting portion 82 of the caliper 13 and the internal thread portion 109b of the tie bar 100 are coincident to each other, that is, arranged to be coaxial.

When the caliper 13 is installed into a vehicle, as described above, in a condition where the tie bar 100 is supported by the mounting portion 82 of the caliper 13 in advance, the surface portion 92a opposite to the tie bar 100 of the mounting boss portion 86a of the mounting portion 82 of the caliper 13 is abutted to the first surface 31a on a side of the disk 11 of the mounting projection 22a of the knuckle 14. Moreover, the surface portion 92b opposite to the tie bar 100 of the mounting boss portion 86b is abutted to the first surface portion 31b on a side of the disk 11 of the mounting projection 22b of the knuckle 14. Then, by positionally adjusting the installation hole 93a of the mounting portion 82 to the installation hole 33a of the knuckle 14, an axial portion 115a of a fixing bolt 114a is installed into the installation hole 33a from a side opposite to the disk 11, and the axial portion 115a of the fixing bolt 114a is inserted into the penetrated hole 95a of the installation hole 93a of the caliper 13. An exterior thread 116a is then screwed into the internal thread portion 109a of the adaptor portion 101a of the tie bar 100. As the same with the above, by positionally adjusting the installation hole 93b of the mounting portion 82 to the installation hole 33b of the knuckle 14, an axial portion 115b of a fixing bolt 114b same with the fixing bolt 114a is installed into the installation hole 33b from a side opposite to the disk 11, and the axial portion 115b of the fixing bolt 114b is inserted into the penetrated hole 95b of the installation hole 93b of the caliper 13. An exterior thread 116b is then screwed into the internal thread portion 109b of the adaptor portion 101b of the tie bar 100. Finally, a head 117a having a diameter larger than the axial portion 115a of the fixing bolt 114a as well as a head 117b having a diameter larger than the axial portion 115b of the fixing bolt 114b are fastened accordingly.

Based on the above, the head 11a of the fixing bolt 114a is abutted to the second surface 32a of the mounting projection 22a of the knuckle 14; the first surface 31a of the mounting projection 22a is abutted to the surface portion 92a of the mounting portion 82 of the caliper 13; the surface portion 91a of the mounting portion 82 of the caliper 13 is abutted to the surface portion 111a of the mounting seat 107a of the tie bar 100; the head 117b of the fixing bolt 114b is abutted to the second surface 32b of the mounting projection 22b of the knuckle 14; the first surface 31b of the mounting projection 22b is abutted to the surface portion 92b of the mounting portion 82 of the caliper 13; and the surface portion 91b of the mounting portion 82 of the caliper 13 is abutted to the surface portion 111b of the mounting seat 107b of the tie bar.

Accordingly, the mounting portion 82 of the caliper 13 and the knuckle 14 are fastened by means of the tie bar 100 and the two fixing bolts 114a, 114b.

In this condition, the tie bar 100 is provided, or more specifically fastened, to the mounting portion 82 of the caliper 13 on a side opposite to the knuckle 14. The tie bar 100 is then integrally connected with the mounting projections 22a, 22b of the knuckle 14 as to connect both mounting projections 22a, 22b in a circumferential direction. The knuckle 14 is reinforced by the fixing bolts 114a, 114b.

Here, by supplying brake fluid from the supply port 65 shown in FIG. 1 to each of the bores 48 of the caliper 13 fixed to the knuckle 14 of a vehicle, two pairs of pistons 60 (four in total) shown in FIG. 2 are synchronously projected in a direction of the disk 11 according to the supply of the brake fluid, whereby two pairs of the lining pads 12 (four in total) are pressed toward the disk 11 generating braking force.

In the Patent Document 1 hereinabove discussed, when the caliper of the disk brake is installed in the knuckle on a vehicle side by means of the two fixing bolts, the tie bar arranged so as to connect the two fixing bolts is fastened tight together with the knuckle by means of two fixing bolts thereby compensating its strength shortage and suppressing brake noise. In this disk brake, in order to form an internal thread portion on the caliper for the fixing bolt to be screwed, in case that the caliper is made of, for example, aluminum alloy, a mounting portion needs to be enlarged to enhance clamping axial force. On the other hand, as to the Patent Document 2 also discussed hereinabove, in the caliper of a disk brake, the individual adaptor with the internal thread hole is provided with the caliper, and the fixing bolt is screwed into the internal thread portion of the adaptor so as to fastening the caliper to a vehicle. For example, by forming the adaptor with materials, strength of which is higher than materials of the caliper, it is possible to increase clamping axial force of the fixing bolt. However, in addition to the tie bar as a reinforcement member to the brake noise, if the adaptor also as a reinforce member to the clamping axial force is added, total numbers of parts need to be increased.

To be contrary, in the first embodiment of the present invention, as shown in FIG. 3, the tie bar 100 is provided with the internal thread portions 109a, 109b and made of materials different from the mounting portion 82 and the knuckle 14. Further, the mounting portion 82 and knuckle 14 are fastened to each other by means of the tie bar 100 and the fixing bolts 114a, 114b screwed into the internal thread portions 109a, 109b of the tie bar 100, whereby it is possible for the tie bar 100 to obtain function of adaptor thereby being able to reduce parts and cost.

Still further, in the first embodiment of the present invention, there is provided with the tie bar 100 that is provided at the mounting portion 82 of the caliper 13. The tie bar 100 includes the internal thread portion 109a into which the fixing bolt 114a is screwed, and the internal thread portion 109b into which the fixing bolt 114b is screwed. The tie bar 100 is made of materials having Young's modulus higher than the mounting portion 82 of the caliper 13. In a condition where the installation hole 93a and the installation hole 93b of the caliper 13 are coincident with the internal thread portion 109a and the internal thread portion 109b, respectively, the tie bar 100 is installed to the mounting portion 82, the tie bar 100 being placed on a side opposite to the knuckle 14. Accordingly, the tie bar 100 can obtain functions of adaptor thereby being able to reduce parts and cost.

In addition, in the first embodiment, there is provided with the metal tie bar 100 that is placed on a side opposite to the knuckle 14, the metal tie bar 100 comprising: the adaptor portion 101a provided with the internal thread portion 109a in which to be fastened to the mounting portion 82 of the caliper 13 by means of the fixing bolt 114a; the adaptor portion 101b provided with the internal thread portion 109b in which to be fastened to the mounting portion 82 by means of the fixing bolt 114b; and the tie-bar portion 102 connecting the adaptor portion 101a with the adaptor portion 101b. The tie bar 100 is made of materials having Young's modulus higher than the mounting portion 82 of the caliper 13. Since the tie bar 100 is fastened to and supported by the mounting portion 82 of the caliper 13 by means of the adaptor portions 101a, 101b, it is possible for the tie bar 100 to obtain functions of adaptor thereby being able to facilitate mounting operations and to reduce parts and cost. Still further, since the tie bar 100 is fastened to and supported by the mounting portion 82 of the caliper 13 by means of the adaptor 101a, it is possible for the tie bar 100 to install to the caliper 13 in advance thereby facilitating mounting operations of the caliper 13 to the knuckle 14.

Hereinabove, the details of the first embodiment have been explained. Operational effects of the first embodiment will be explained hereinbelow.

In the first embodiment, there is provided with the metal tie bar 100 that is placed on a side opposite to the knuckle 14, the metal tie bar 100 comprising: the adaptor portion 101a provided with the internal thread portion 109a in which to be fastened to the mounting portion 82 of the caliper 13 by means of the fixing bolt 114a; the adaptor portion 101b provided with the internal thread portion 109b in which to be fastened to the mounting portion 82 of the caliper 13 by means of the fixing bolt 114b; and the tie-bar portion 102 connecting the adaptor portion 101a with the adaptor portion 101b. The tie bar 100 is made of materials having Young's modulus higher than the mounting portion 82 of the caliper 13 and the knuckle 14 each made of aluminum alloy. The tie bar 100 is fastened to and supported by the mounting portion 82 of the caliper 13 by means of the adaptor portions 101a. Moreover, the exterior thread 116a of the fixing bolt 114a that is screwed into the straight installation hole 33a of the knuckle 14 and the penetrated hole 95a of the mounting portion 82 of the caliper 13 is also screwed into the internal thread portion 109a of the tie bar 100. In the same way, the exterior thread 116b of the fixing bolt 114b that is screwed into the straight installation hole 33b of the knuckle 14 and the penetrated hole 95b of the mounting portion 82 of the caliper 13 is also screwed into the internal thread portion 109b of the tie bar 100. Accordingly, the mounting portion 82 of the caliper 13 and the knuckle 14 can be fastened to each other by means of the fixing bolts 114a, 114b and the tie bar 100. Here, it is possible for the tie bar 100 to obtain functions of adaptor thereby being able to reduce parts and cost.

Since the tie bar 100 is fastened to and supported by the mounting portion 82 of the caliper 13 by means of the adaptor 101a, it is possible for the tie bar 100 to install to the caliper 13 in advance thereby facilitating mounting operations of the caliper 13 to the knuckle 14.

Further, since the tie bar 100 is fastened to the mounting portion 82 of the caliper 13 by means of the adaptor portions 101a, 101b, the adaptor portions 101a, 101b being connected to each other by the tie-bar portion 102, it is possible to prevent that the adaptor portions 101a, 101b will perform simultaneous bolt-nut rotation when the fixing bolts 114a, 114b are screwed. Accordingly, mounting operations of the caliper 13 to the knuckle can be facilitated.

Still further, when the tie bar 100 is supported by the caliper 13 before the caliper 13 and the knuckle 14 are fastened, the internal thread portion 109a and the installation hole 93a are coincident to each other while the internal thread portion 109b and the installation hole 93b are also coincident to each other. Accordingly, the fixing bolt 114a can be screwed into the internal thread portion 109a by inserting the fixing bolt 114a into the penetrated hole 95a of the installation hole 93a from the knuckle 14 side. In the same manner, the fixing bolt 114b can also be screwed into the internal thread portion 109b by inserting the fixing bolt 114b into the penetrated hole 95b of the installation hole 93b from the knuckle 14 side. Accordingly, it is possible to facilitate that the fixing bolts 114a, 114b are screwed into the tie bar 100. Mounting operations of the caliper 13 to the knuckle 14 can be thus eased.

Moreover, since the tie bar 100 is fastened to and supported by the caliper 13, there will be no need to have any exclusive equipment to support the tie bar 100. Accordingly, reduction of parts and cost can be further advanced.

In addition, the mounting portion 82 of the caliper 13 is provided with the recesses 94a, 94b while the tie bar 100 is provided with the projection portion 108a and the projection portion 108b to be screwed into the recess 94a and the recess 94b, respectively. Since the projection portion 108a is provided with the internal thread portion 109a while the projection portion 108b is provided with the internal thread portion 109b, it is possible to secure each length of the internal thread portions 109a, 109b. Accordingly, it is also possible to further enhance clamping axial force of the fixing bolts 114a, 114b.

Further, in the tie bar 100, two adaptor portions 101a, 101b are provided with two projection portions 108a, 108b. Since the projection portion 108a of the adaptor portion 101a is press-fitted into the mounting portion 82, the tie bar 100 is supported by the mounting portion 82 of the caliper 13 thereby facilitating supporting operations of the tie bar 100 to the mounting portion 82. In addition, since any exclusive equipment to support the tie bar 100 is not necessary, it is possible to reduce the number of parts.

Still further, in the adaptor portions 101a, 101b of the tie bar 100, the projection portion 108a of the adaptor portion 101a is press-fitted into the recess 94a of the mounting portion 82 while the projection portion 108b of the adaptor portion 101b is loosely fitted into the recess 94b of the mounting portion 82. The tie bar 100 is supported by the mounting portion 82 of the caliper 13. Accordingly, supporting operations of the tie bar 100 to the mounting portion 82 can be further facilitated, and tolerance between the projection portions 108a, 108b can be also absorbed.

In the first embodiment of the present invention discussed hereinabove, only one pair of lining pads 12 may be enough. Further, the number of the installation holes 33a, 33b of the knuckle 14 may also be only two (at least two). As the same, the number of the installation holes 93a, 93b of the mounting portion 82 of the caliper 13, the number of the adaptor portions 101a, 101b of the tie bar 100, and the number of the internal thread portions 109a, 109b of the tie bar 100 may also be at least two.

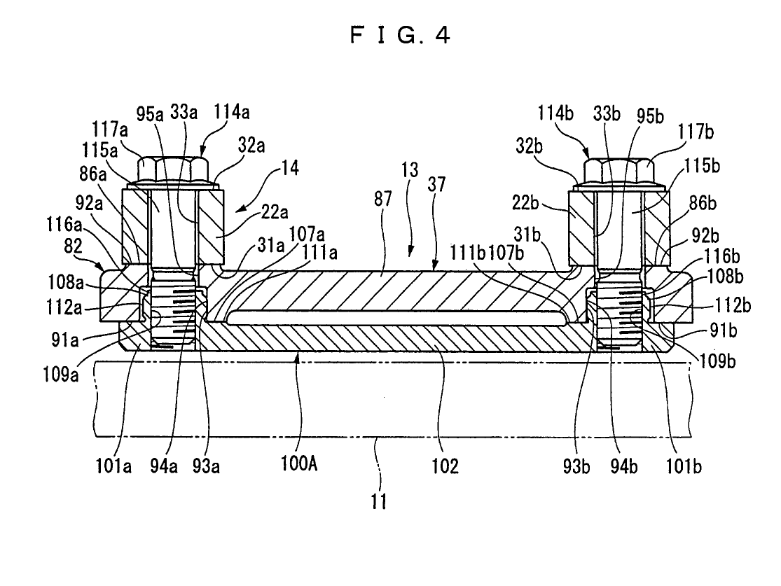

Next, a second embodiment of the present invention will be discussed mainly with reference to FIG. 4. The discussion will be mainly differences from the first embodiment.

FIG. 4 is a cross-sectional view of a disk brake according to the second embodiment of the present invention, which is taken along a line X1-X1 as shown in FIG. 1. Any component parts corresponding to those in the first embodiment are denoted by the same reference numerals.

In the second embodiment of the present invention as shown in FIG. 4, a tie bar 100A slightly different from the tie bar 100 of the first embodiment is installed to the mounting portion 82 of the caliper 13 of the first embodiment. Differences between the tie bar 100A of the second embodiment and the tie bar 100 of the first embodiment are as follows.

In addition to the projection portion 108a of the adaptor portion 101a placed on one side in a disk circumferential direction, the tie bar 100A is also provided with an annular convex portion 112b at the projection portion 108b of the adaptor portion 101b (placed on the other side in a disk circumferential direction). The outer diameter of the annular convex portion 112b becomes narrower in an axial direction as moving outward in a radius direction. The diameter of the projection portion 108a is identical with the one of the projection portion 108b. Accordingly, the tie bar 100A is symmetrically formed. Here, in the tie bar 100A, outer diameters of the projection portions 108a, 108b are set to be slightly smaller than inner diameters of the recesses 94a, 94b of the mounting portion 82 of the caliper 13. Further, a center distance between the projection portions 108a, 108b is set to be shorter than a center distance between the recesses 94a, 94b.

Accordingly, in the tie bar 100A, the annular convex portions 112a, 112b of the projection portions 108a, 108b will pinch wall surfaces of the recesses 94a, 94b (the wall surfaces facing to each other). The tie bar 100A is fastened to and supported by the mounting portion 82 accordingly. Here, in a condition where the tie bar 100A is supported by the mounting portion 82, in order to make the center of the internal thread portion 109a coincident with the center of the installation hole 93a, the internal thread portion 109a is slightly deviated to a side opposite to the projection portion 108b relative to the center of the projection portion 108a. In the same manner, in order to make the center of the internal thread portion 109b coincident with the center of the installation hole 93b, the internal thread portion 109b is slightly deviated to a side opposite to the projection portion 108a relative to the center of the projection portion 108b.

In the second embodiment, the tie bar 100A that is approximately the same with the first embodiment can be installed to the mounting portion 82 of the caliper 13, whereby effects approximately the same with the first embodiment are obtainable. Further, as to the supporting method of the tie bar 100A to the mounting portion 82, the tie bar 100A has two adaptor portions 101a, 101b that are provided with two projection portions 108a, 108b. The tie bar 100A is fastened to the mounting portion 82 in such a manner that the projection portions 108a, 108b are adapted to pinch the wall surfaces of the recesses 94a, 94b (the wall surfaces facing to each other). Accordingly, as the same with the first embodiment, supporting operations of the tie bar 100A to the mounting portion 82 will be facilitated.

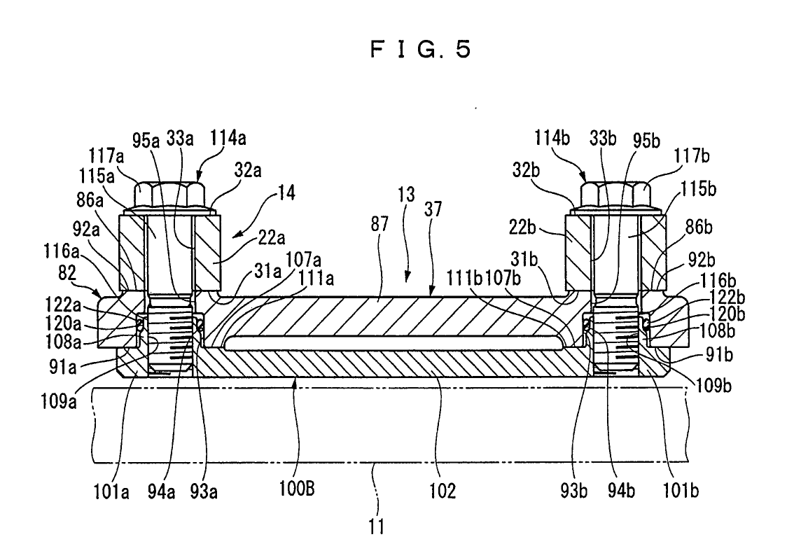

Hereinbelow, a third embodiment of the present invention will be explained with reference to FIGS. 5 to 7. Some points different from the first embodiment will be mainly explained.

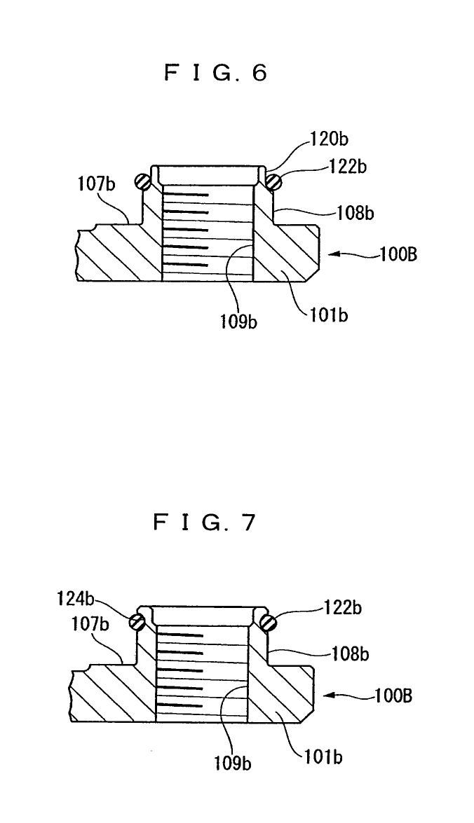

FIG. 5 is a cross-sectional view of a disk brake according to the third embodiment of the present invention, which is taken along a line X1-X1 as shown in FIG. 1. FIG. 6 is a cross-sectional view partially enlarging a tie bar of the disk brake according to the third embodiment of the present invention. FIG. 7 is a cross-sectional view partially enlarging a modified example of the tie bar of the disk brake according to the third embodiment of the present invention. Any component parts corresponding to those in the first embodiment are denoted by the same reference numerals.

According to the third embodiment in FIG. 5, a tie bar 100 B slightly different from the tie bar 100 of the first embodiment is installed to the mounting portion 82 of the caliper 13 in the first embodiment. Different points between the tie bar 100B and the tie bar 100 of the first embodiment are as follows.

The tie bar 100B is provided with the projection portion 108a of the adaptor portion 101a placed on one side in a disk circumferential direction, and the projection portion 108b of the adaptor portion 101b on the other side in the disk circumferential direction, the projection portions 108a, 108b being identical in their diameters. Here, both the projection portions 108a, 108b are not provided with the annular convex portions as discussed hereinabove. The tie bar 100B is instead provided with: an annular notch portion 120a on a tip external diameter of the projection portion 108a, the notch portion 120a being formed up to a top end of the projection portion 108a; and an annular notch portion 120b also on a tip external diameter of the projection portion 108b, the notch portion 120b being formed up to a top end of the projection portion 108b. The notch portions 120a, 120b both have the same diameter and the same length. That is, the tie bar 100B is formed in a symmetrical manner. Further, in the tie bar 100B, a rubber O-ring (elastic member) 122a is fastened to the notch portion 120a formed on the tip external diameter of the projection portion 108a, the O-ring 122a being supported by its own elastic force. In the same manner, as shown in FIG. 6, a rubber O-ring (elastic member) 122b of the same kind of the O-ring 122a is fastened to the notch portion 120b formed on the tip external diameter of the projection portion 108b, the O-ring 122b being supported by its own elastic force.

Here, as shown in FIG. 5, external diameters of the projection portions 108a, 108b are set to be slightly smaller than the recesses 94a, 94b of the mounting portion 82 of the caliper 13. Further, the external diameters of the O-rings 122a, 122b supported by the notch portions 120a, 120b of the projection portions 108a, 108b are set to be slightly larger than the recesses 94a, 94b before the O-rings 122a, 122b are fastened to the recesses 94a, 94b. In addition, a center distance between the projection portions 108a, 108b is set to be identical with a center distance between the recesses 94a, 94b.

Accordingly, by fastening the projection portion 108a of the tie bar 100B to the recess 94a of the mounting portion 82, and in the same manner, by fastening the projection portion 108b to the recess 94b, the O-ring 122a is tightly fastened to the wall surface of the recess 94a by the diameter difference described hereinabove, the O-ring 122a being pressed in a radius direction. The O-ring 122a thus intervenes between the projection portion 108a and the recess 94a. In the same manner, the O-ring 122b is tightly fastened to the wall surface of the recess 94b by the diameter difference described hereinabove, the O-ring 122b being pressed in a radius direction. The O-ring 122b thus intervenes between the projection portion 108b and the recess 94b. With elastic force and frictional force generated hereinabove, the tie bar 100B is supported by the mounting portion 82.

In the third embodiment of the present invention, since the tie bar 100B approximately identical with the first embodiment is installed to the mounting portion 82 of the caliper 13, effects approximately identical with the first embodiment are obtainable. Further, as to the supporting method of the tie bar 100B to the mounting portion 82 that is different from the first embodiment, the O-ring 122a provided at the projection portion 108a of the tie bar 100B is adapted to intervene between the projection portion 108a and the recess 94a. In the same manner, the O-ring 122b provided at the projection portion 108b is adapted to intervene between the projection portion 108b and recess 94b. The tie bar 100B is thus supported by the mounting portion 82. Accordingly, as the same with the first embodiment, supporting operations of the tie bar 100B to the mounting portion 82 will be facilitated. Further it makes possible that the tie bar 100B can be manually retained to the caliper 13, whereby no additional equipment for fastening the tie bar 100B to the caliper 13 will be needed. Still further, working tolerance can be absorbed by deformation of the O-rings 122a, 122b.

Here, the projection portions 108a, 108b are both modifiable as follows.

Only the side of the projection portion 108b will be explained hereinbelow with reference to FIG. 7. An annular seal groove 124b is provided on a tip external diameter of the projection portion 108b of the tie bar 100B, the seal groove 124b being not formed up to the most tip of the projection portion 108b. The rubber O-ring 122b is fastened to and supported by the seal groove 124b. In this case also, the external diameter of the O-ring 122b supported by the seal groove 124b of the projection portion 108b is set to be slightly larger than the inner diameter of the recess 94b. With this configuration, it is possible to have the same effects discussed hereinabove. Furthermore, it is possible to prevent the O-ring 122b from being slipped off from the most top of the projection portion 108b. The tie bar 100B can be thus supported by the caliper 13 with further strength.

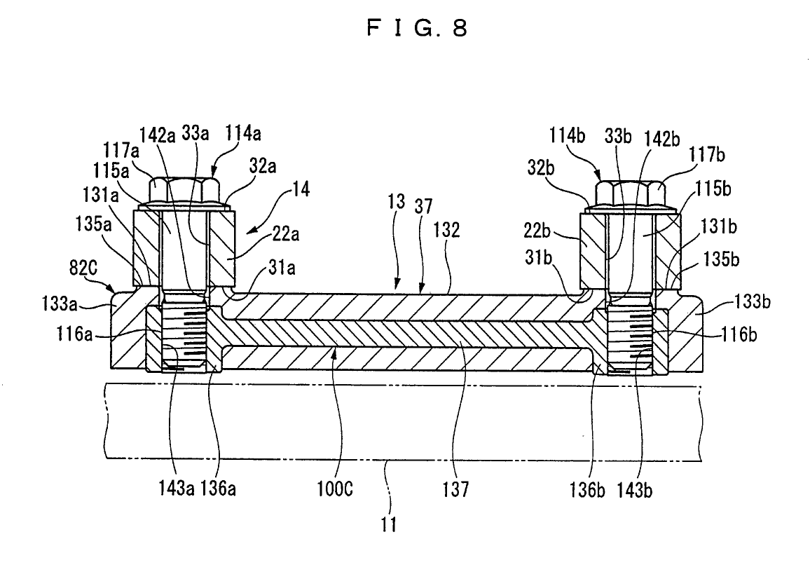

Next, a fourth embodiment of the present invention will be discussed with reference to FIG. 8. The discussion will be mainly differences from the first embodiment.

FIG. 8 is a cross-sectional view of a disk brake according to the fourth embodiment of the present invention, which is taken along a line X1-X1 as shown in FIG. 1. Any component parts corresponding to those in the first embodiment are denoted by the same reference numerals.

In the fourth embodiment as shown in FIG. 8, a mounting portion 82C different from the mounting portion 82 of the first embodiment is provided. When the aluminum alloy inner caliper half body 37 is formed by die casting mold, an integral molding tie bar (reinforcement member) 100C made of iron (cast iron or steel) is molded to the mounting portion 82C.

The mounting portion 82C of the fourth embodiment is formed in a symmetrical manner, and provided with a pair of mounting boss portion 131a and mounting boss portion 131b on both ends in a disk circumferential direction, the mounting boss portions 131a, 131b slightly projecting to a side opposite to the disk 11 in a disk axial direction. Further, the mounting portion 82C is provided with an intermediate connecting portion 132 so as to connect the mounting boss portions 131a, 131b, the intermediate connecting portion 132 being slightly thinner than the mounting boss portions 131a, 131b in a disk axial direction. Still further, the mounting portion 82C is also provided with a distal formation portion 133a on the mounting boss portion 131a (on a side opposite to the mounting boss portion 131b), the distal formation portion 133a being slightly thinner than the mounting boss portion 131a in a disk axial direction. In the same manner, on the mounting boss portion 131b (on a side opposite to the mounting boss portion 131a), a distal formation portion 133b that is slightly thinner than the mounting boss portion 131b in a disk axial direction is provided.

At the mounting boss portion 131a placed on one side in a disk circumferential direction, a surface portion 135a is provided on a side opposite to the disk 11, the surface portion 135a being orthogonal to a disk axis. In the same manner, at the mounting boss portion 131b on the other side in a disk circumferential direction, a surface portion 135b is formed so as to be coplanar with the surface portion 135a.

The tie bar 100C according to the fourth embodiment is symmetrically formed, and molded to deviate to a side of the disk 11 (a side opposite to the knuckle 14). The tie bar 100C is provided with adaptor portions 136a, 136b on both ends in a disk circumferential direction, the adaptor portions 136a, 136b being formed in a symmetrical manner. Further, a tie bar portion 137 is formed so as to connect the adaptor portions 136a, 136b.

The adaptor portion 136a placed on one side in a disk circumferential direction is formed as that one side of the adaptor portion 136a (on a side opposite to the disk 11) slightly projects in a disk axial direction relative to the tie bar portion 137 (one-side projection) while the other side (on a side facing the disk 11) projects toward the disk 11 more than the one-side projection. Although not shown in FIGS, the adaptor portion 136a is made into a circular form having a diameter larger than the width of the tie bar portion 137 in a disk radius direction. Moreover, in the adaptor portion 136a, the end portion on a side of the disk 11 projects toward the disk 11 so as to protrude further from the mounting portion 82C while the other end portion on a side opposite to the disk 11 is arranged within the mounting portion 82C. Here, the center of the adaptor portion 136a is coincident with the one of the mounting boss portion 131a of the mounting portion 82C.

An installation hole (a first installation hole) 142a is formed from the center portion of the surface portion 135a of the mounting boss portion 131a of the mounting portion 82C to the adaptor portion 136a in a direction of the disk axis. Further, the adaptor portion 136a is provided with an internal thread portion 143a in which to penetrate the center thereof in a direction of the disk axis, the internal thread portion 143a being connected with the installation hole 142a. These installation hole 142a and internal thread portion 143a are formed in a condition where the tie bar 100C has been molded into the mounting portion 82C.

The adaptor portion 136b placed on the other side in a disk circumferential direction is also formed as that one side of the adaptor portion 136b (on a side opposite to the disk 11) slightly projects in a disk axial direction relative to the tie bar portion 137 (one-side projection) while the other side (on a side facing the disk 11) projects toward the disk 11 more than the one-side projection. Although not shown in FIGS, the adaptor portion 136b is made into a circular form having a diameter larger than the width of the tie bar portion 137 in a disk radius direction. Moreover, in the adaptor portion 136b, the end portion on a side of the disk 11 projects toward the disk 11 so as to protrude further from the mounting portion 82C while the other end portion on a side opposite to the disk 11 is arranged within the mounting portion 82C. Here, the center of the adaptor portion 136b is coincident with the one of the mounting boss portion 131b of the mounting portion 82C.

An installation hole (a first installation hole) 142b is formed from the center portion of the surface portion 135b of the mounting boss portion 131b of the mounting portion 82C to the adaptor portion 136b in a direction of the disk axis. Further, the adaptor portion 136b is provided with an internal thread portion 143b in which to penetrate the center thereof in a direction of the disk axis, the internal thread portion 143b being connected with the installation hole 142b. These installation hole 142b and internal thread portion 143b are formed in a condition where the tie bar 100C has been molded into the mounting portion 82C.

When the caliper 13 is installed into a vehicle, the caliper 13 where the tie bar 100C has been molded into the mounting portion 82C is abutted to the knuckle 14. More specifically, the surface portion 135a of the mounting boss portion 131a on a side opposite to the tie bar 100C is abutted to the surface portion 31a of the mounting projection 22a of the knuckle 14, and the surface portion 135b of the mounting boss portion 131b on a side opposite to the tie bar 100C is abutted to the surface portion 31b of the mounting projection 22b of the knuckle 14. Then, after the installation hole 142a of the mounting portion 82C is positionally adjusted to the installation hole 33a of the knuckle 14, the axial portion 115a of the fixing bolt 114a is inserted into the installation hole 33a from a side opposite to the disk 11. By inserting the axial portion 115a of the fixing bolt 114a into the installation hole 142a of the caliper 13, the exterior thread 116a is screwed into the internal thread portion 143a of the adaptor portion 136a of the tie bar 100C. In the same manner, after the installation hole 142b of the mounting portion 82C is positionally adjusted to the installation hole 33b of the knuckle 14, the axial portion 115b of the fixing bolt 114b is inserted into the installation hole 33b from a side opposite to the disk 11. By inserting the axial portion 115b of the fixing bolt 114b into the installation hole 142b of the caliper 13, the external thread 116b is screwed into the internal thread portion 143b of the adaptor portion 136b of the tie bar 100C. The external threads 116a, 116b fasten the head 117a of the fixing bolt 114a and the head 117b of the fixing bolt 114b.

Accordingly, the head 117a of the fixing bolt 114a is abutted to the second surface 32a of the mounting projection 22a of the knuckle 14 while the first surface 31a of the mounting projection 22a is abutted to the surface portion 135a of the mounting portion 82C of the caliper 13. In the same manner, the head 117b of the fixing bolt 114b is abutted to the second surface 32b of the mounting projection 22b of the knuckle 14 while the first surface 31b of the mounting projection 22b is abutted to the surface portion 135b of the mounting portion 82C of the caliper 13. Accordingly, the mounting portion 82C of the caliper 13 and the knuckle 14 are fastened to each other by means of the tie bar 100C and two fixing bolts 114a, 114b. This means that the caliper 13 is installed to a vehicle.

In the above condition, the tie bar 100C is placed on a side opposite to the knuckle 14 relative to the mounting portion 82C of the caliper 13 and is installed to the mounting portion 82C. To be more specific, the tie bar 100C is integrally molded into the mounting portion 82C. Further, in the condition, the tie bar 100C is integrally formed with the mounting projections 22a, 22b so as to connect these mounting projections 22a, 22b in a disk circumferential direction. The fixing bolts 114a, 114b are then installed into the knuckle 14.

In the fourth embodiment of the present invention discussed hereinabove, the tie bar 100C comprises: the adaptor portion 136a that is placed on a side opposite to the knuckle 14 and being provided with the internal thread portion 143a into which the fixing bolt 114a is screwed, the adaptor portion 136a being molded into the mounting portion 82C of the caliper 13; the adaptor portion 136b that is placed on a side opposite to the knuckle 14 and being provided with the internal thread portion 143b into which the fixing bolt 114b is screwed, the adaptor portion 136b being molded into the mounting portion 82C of the caliper 13; and the tie bar portion 137 connecting the adaptor portions 136a, 136b. The tie bar 100C is made of iron having Young's modulus higher than the mounting portion 82C and the knuckle 14 each made of aluminum alloy. This tie bar 100C is molded into the mounting portion 82C of the caliper 13. Then, the external thread 116a of the fixing bolt 114a that is screwed into the installation hole 33a of the knuckle 14 as well as the installation hole 142a of the mounting portion 82C of the caliper 13 is screwed into the internal thread portion 143a of the tie bar 100C while the external thread 116b of the fixing bolt 114b that is screwed into the installation hole 33b of the knuckle 14 as well as the installation hole 142b of the mounting portion 82C of the caliper 13 is screwed into the internal thread portion 143b of the tie bar 100C. Accordingly, the mounting portion 82C of the caliper 13 and the knuckle 14 can be fastened to each other by means of the fixing bolts 114a, 114b and the tie bar 100C, whereby it is possible for the tie bar 100C to obtain functions of adaptor. Thus, mounting operations between the caliper 13 and the knuckle 14 can be facilitated while parts and cost can be reduced.

Further, since the tie bar 100C is molded into the mounting portion 82C of the caliper 13, it will be not necessary to have a process that the tie bar 100C is installed to the caliper 13. Accordingly, mounting operations of the caliper 13 to the knuckle 14 becomes further easier.

Still further, in the tie bar 100C, before the caliper 13 is fastened to the knuckle 14 by means of the fixing bolts 114a, 114b, the internal thread portion 143a and the installation hole 142a are coincident to each other while the internal thread portion 143b and the installation hole 142b are coincident to each other so as to be supported by the caliper 13. Accordingly, the fixing bolt 114a can be screwed into the internal thread portion 143a by inserting into the installation hole 142a from a side of the knuckle 14 while the fixing bolt 114b also can be screwed into the internal thread portion 143b by inserting into the fixing hole 142b from a side of the knuckle 14. Accordingly, screwing of the fixing bolts 114a, 114b to the tie bar 100C can be facilitated. Thus, mounting operations of the caliper 13 to the knuckle 14 can be eased.

Furthermore, since the tie bar 100C is molded into the caliper 13, exclusive equipments to support the tie bar 100C will not be necessary. Accordingly, it is possible to further reduce parts and cost.

In the fourth embodiment also, the number of the installation holes 33a, 33b of the knuckle 14 may also be only two (at least two). As the same, the number of the installation holes 142a, 142b of the mounting portion 82 of the caliper 13, the number of the adaptor portions 136a, 136b of the tie bar 100C, and the number of the internal thread portions 143a, 143b of the tie bar 100C may also be at least two.

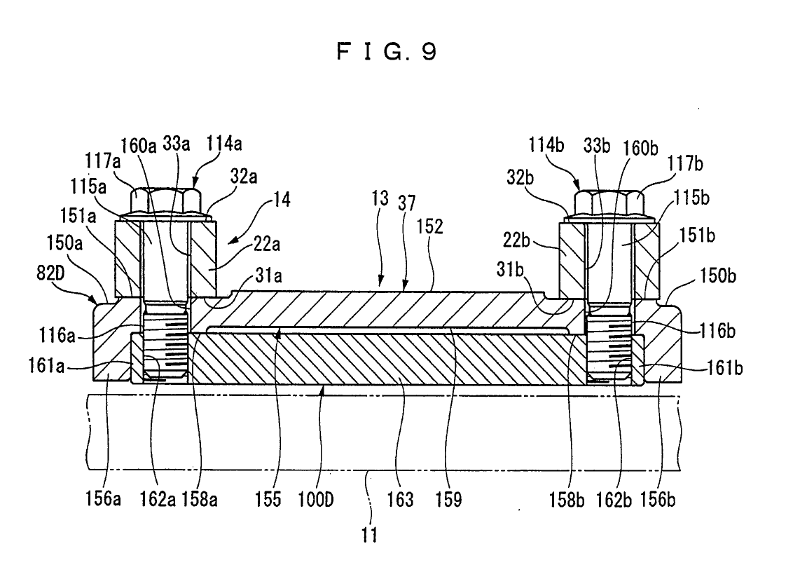

Next, a fifth embodiment of the present invention will be described mainly with reference to FIG. 9. The discussion will be mainly differences from the first embodiment.

FIG. 9 is a cross-sectional view of a disk brake according to the fifth embodiment of the present invention, which is taken along a line X1-X1 as shown in FIG. 1. Any component parts corresponding to those in the first embodiment are denoted by the same reference numerals.

In the fifth embodiment as shown in FIG. 9, a mounting portion 82D that is different from the mounting portion 82 of the first embodiment is provided to the integral molding inner caliper half body 37 made of aluminum alloy.

At the mounting portion 82D on a side opposite to the disk 11, stepped surfaces 150a, 150b are provided on both ends in a disk circumferential direction, the stepped surfaces 150a, 150b being orthogonal in a disk axial direction and being coplanar to each other. At portions inside of the both stepped surfaces 150a, 150b in a radius direction of the disk 11, abutting surface portions 151a, 151b are arranged so as to be coplanar to each other, the abutting surface portions 151a, 151b being deviated to a side opposite to the disk 11 relative to the stepped surfaces 150a, 150b and being orthogonal in a disk axial direction. Further, between the abutting surface portions 151a, 151b, a connecting surface portion 152 is provided so as to be orthogonal in a disk axial direction, the connecting surface portion 152 being deviated to a side opposite to the disk 11 relative to abutting surface portion 151a, 151b.

Furthermore, on the disk 11 side of the mounting portion 82D, a retaining concave portion 155 that extends in a disk circumferential direction is formed, the retaining concave portion 155 being able to concave to a side opposite to the disk 11. On the both ends in a disk circumferential direction, retaining wall portions 156a, 156b are provided, the retaining wall portions 156a, 156b projecting to a side of the disk 11 in a disk axial direction. On a bottom portion of the retaining concave portion 155 (both end sides thereof), a retaining surface portion 158a is provided on the disk 11 side of the abutting surface portion 151a so as to be orthogonal in a disk axial direction while a retaining surface portion 158b is provided on the disk 11 side of the abutting surface portion 151b so as to be orthogonal in a disk axial direction. Both the retaining surface portion 158a and the retaining surface portion 158b are arranged to be coplanar to each other. Still further, between the retaining surface portions 158a, 158b of the bottom portion of the retaining concave portion 155, a relief portion 159 is formed so as to be slightly deviated to a side opposite to the disk 11 relative to the retaining surface portions 158a, 158b, the relief portion 159 being orthogonal in a disk axial direction.

Here, on the mounting portion 82D, an installation hole (a first installation hole) 160a is provided so as to penetrate in a disk axial direction, the installation hole 160a being formed as that the abutting surface portion 151a and the retaining surface portion 158a both provided on one side in a disk circumferential direction are connected by each center thereof. In the same manner, an installation hole (a first installation hole) 160b is provided so as to penetrate in a disk axial direction, the installation hole 160b being formed as that the abutting surface portion 151b and the retaining surface portion 158b both provided on the other side in a disk circumferential direction are connected by each center thereof. In the fifth embodiment, the mounting portion 82D is also formed in a symmetrical manner.

Further, also in the fifth embodiment, on the mounting portion 82D of the integral molding inner caliper half body 37 made of aluminum alloy, an integral molding tie bar (reinforcement member) 100D made of iron (cast iron or steel) is supported.

The tie bar 100D is symmetrically formed and is a plate with a thickness constant in a disk axial direction. The tie bar 100D is formed with an adaptor portion 161a and an adaptor portion 161b symmetrically on both end sides in a disk circumferential direction. An internal thread portion 162a is axially penetrated into the center portion of the adaptor portion 161a placed on one side in a disk circumferential direction while an internal thread portion 162b is axially penetrated into the center portion of the adaptor portion 161b placed on the other side in a disk circumferential direction. The adaptor portions 161a, 161b are connected with a tie bar portion 163.

Here, the length of the tie bar 100D in a disk circumferential direction is set to be longer than the distance between the retaining wall portions 156a, 156b of the mounting portion 82D for interference.

This tie bar 100D is, prior to installation to a vehicle side of the caliper 13, supported within the retaining concave portion 155 of the mounting portion 82D of the caliper 13. Here, the adaptor portions 161a, 161b placed on both sides of the tie bar 100D in its longitudinal direction are fastened between the retaining wall portions 156a, 156b of the mounting portion 82D with interference. Accordingly, the tie bar 100D is supported by the mounting portion 82D of the caliper 13.

In a condition where the tie bar 100D is supported by the mounting portion 82D, the tie bar 100D is abutted to the retaining surface portions 158a, 158b of the mounting portion 82D of the caliper 13, so that the installation hole 160a of the mounting portion 82D of the caliper 13 is coincident with the internal thread portion 162a of the tie bar 100D, that is, the installation hole 160a and the internal thread portion 162b being coaxially arranged. In the same manner, the installation hole 160b of the mounting portion 82D of the caliper 13 and the internal thread portion 162b of the tie bar 100D are coincident to each other so as to be arranged in a coaxial manner.

In case that the caliper 13 is assembled to a vehicle, as discussed hereinabove, in a condition where the tie bar 100D is supported by the mounting portion 82D of the caliper 13 in advance, the abutting surface portion 151a on a side opposite to the tie bar 100D of the mounting portion 82d of the caliper 13 is abutted to the first surface 31a of the mounting projection 22a of the knuckle 14 while the abutting surface portion 151b is abutted to the first surface 31b of the mounting projection 22b of the knuckle 14. Then, by positionally adjusting the installation hole 160a of the mounting portion 82D to the installation hole 33a of the knuckle 14, the axial portion 115a of the fixing bolt 114a is inserted into the installation hole 33a from a side opposite to the disk 11. After the axial portion 115a of the fixing bolt 114a is inserted into the installation hole 160a of the caliper 13, the exterior thread 116a is screwed into the internal thread portion 162a of the adaptor portion 161a of the tie bar 100D. In the same manner, by positionally adjusting the installation hole 160b of the mounting portion 82D to the installation hole 33b of the knuckle 14, the axial portion 115b of the fixing bolt 114b is inserted into the installation hole 33b from a side opposite to the disk 11. After the axial portion 115b of the fixing bolt 114b is inserted into the installation hole 160b of the caliper 13, the exterior thread 116b is screwed into the internal thread portion 162b of the adaptor portion 161b of the tie bar 100D. Finally, the head 117a of the fixing bolt 114a and the head 117b of the fixing bolt 114b are fastened.

Accordingly, the head 117a of the fixing bolt 114a is abutted to the second surface 32a of the mounting projection 22a of the knuckle 14, the first surface 31a of the mounting projection 22a is abutted to the abutting surface portion 151a of the mounting portion 82D of the caliper 13, the retaining surface portion 158a of the mounting portion 82D of the caliper 13 is abutted to the tie bar 100D, the head 117b of the fixing bolt 114b is abutted to the second surface 32b of the mounting projection 22b of the knuckle 14, the first surface 31b of the mounting projection 22b is abutted to the abutting surface portion 151b of the mounting portion 82D of the caliper 13, and the retaining surface portion 158b of the mounting portion 82D of the caliper 13 is abutted to the tie bar 100D. As discussed above, the mounting portion 82D of the caliper 13 and the knuckle 14 are fastened to each other by means of the tie bar 100D and two fixing bolts 114a, 114b. That is, the caliper 13 is installed to a vehicle.

In the above condition, the tie bar 100D is placed on a side opposite to the knuckle 14 relative to the mounting portion 82D of the caliper 13, and provided to the mounting portion 82D, more specifically, fastened to the mounting portion 82D. Then, the tie bar 100D is fastened to the mounting projections 22a, 22b so as to connect the mounting projections 22a, 22b in a disk circumferential direction. The knuckle 14 is reinforced by the fixing bolts 114a, 114b.

In the fifth embodiment discussed hereinabove, the tie bar 100D is provided on a side opposite to the knuckle 14, the tie bar 100D being fastened to the mounting portion 82D of the caliper 13. The tie bar 100D is provided with the internal thread portion 162a into which the fixing bolt 114a is screwed and the internal thread portion 162b into which the fixing bolt 114b is screwed, the tie bar 100D being made of iron having Young's modulus higher than the mounting portion 82D and the knuckle 14 each made of aluminum alloy. The tie bar 100D is fastened to and supported by the mounting portion 82D of the caliper 13 by means of the adaptor portions 161a, 161b. The external thread 116a of the fixing bolt 114a inserted into the installation hole 33a of the knuckle 14 as well as the installation hole 160a of the mounting portion 82D of the caliper 13 is screwed into the internal thread portion 162a of the adaptor portion 161a of the tie bar 100D In the same manner, the external thread 116b of the fixing bolt 114b inserted into the installation hole 33b of the knuckle 14 as well as the installation hole 160b of the mounting portion 82D of the caliper 13 is screwed into the internal thread portion 162b of the adaptor portion 161b of the tie bar 100D. Accordingly, the mounting portion 82D of the caliper 13 and the knuckle 14 are fastened to each other by means of the fixing bolts 114a, 114b and the tie bar 100D, whereby it is possible for the tie bar 100D to obtain functions of adaptor. Mounting operations of the tie bar 100D to the caliper 13 can be thus facilitated, and parts and cost can be reduced.

Further, since the tie bar 100D is fastened to and supported by the mounting portion 82D of the caliper 13 by means of the adaptor portions 161a, 161b, the tie bar 100D can be installed to the caliper 13 in advance, whereby mounting operations of the caliper 13 to the knuckle 14 can be facilitated.

Still further, in the tie bar 100D, before the caliper 13 and the knuckle 14 are fastened to each other by means of the fixing bolts 114a, 114b, the internal thread portion 162a of the adaptor portion 161a and the installation hole 160a are coincident to each other while the internal thread portion 162b of the adaptor portion 161b and the installation hole 160b are coincident to each other. Since the tie bar 100D is supported by the caliper 13 in the above condition, the fixing bolt 114a can be screwed into the internal thread portion 162a by inserting the fixing bolt 114a into the installation hole 160a from a side of the knuckle 14 while the fixing bolt 114b can be also screwed into the internal thread portion 162b by inserting the fixing bolt 114b into the installation hole 160b from a side of the knuckle 14. Accordingly, the fixing bolts 114a, 114b can be easily screwed into the tie bar 100D. That is, mounting operations of the caliper 13 to the knuckle 14 can be further eased.

Moreover, since the tie bar 100D is fastened to and supported by the caliper 13 by means of the adaptor portions 161a, 161b, any exclusive equipment to support the tie bar 100D is not necessary, whereby parts and cost can be further reduced.

In addition, tie bar 100D is retained between the retaining wall portions 156a, 156b of the mounting portion 82D through the adaptor portions 161a, 161b placed at both ends of the tie bar 100D in a longitudinal direction. Accordingly, it is possible for the tie bar 100D to be formed without any projections, etc. thereby being able to reduce manufacturing cost thereof.

In the fifth embodiment also, the number of the installation holes 33a, 33b of the knuckle 14 may also be only two (at least two). As the same, the number of the installation holes 160a, 160b of the mounting portion 82D of the caliper 13, the number of the adaptor portions 161a, 161b of the tie bar 100D, and the number of the internal thread portions 162a, 162b of the tie bar 100D may also be at least two.

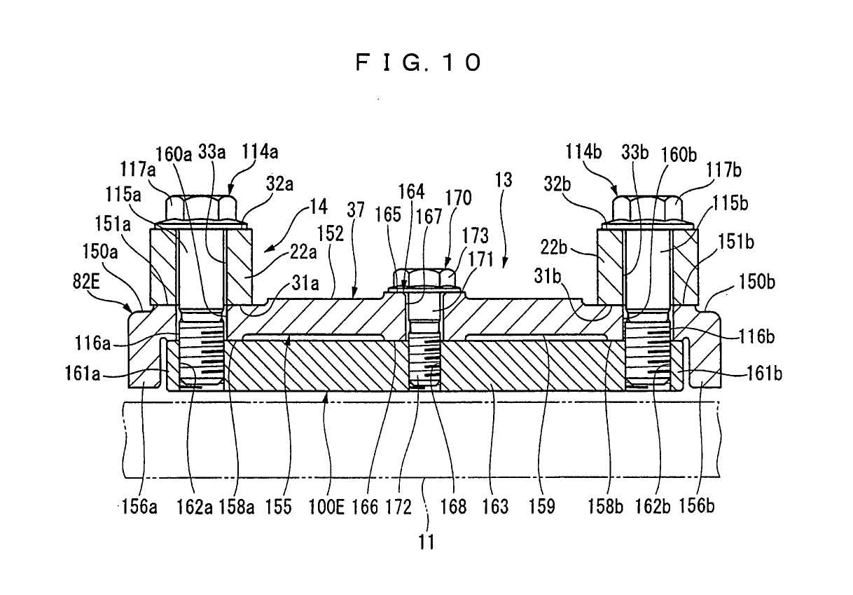

Next, a sixth embodiment of the present invention will be discussed with reference to FIG. 10. The discussion will be mainly differences from the fifth embodiment.

FIG. 10 is a cross-sectional view of a disk brake according to the sixth embodiment of the present invention, which is taken along a line X1-X1 as shown in FIG. 1. Any component parts corresponding to those in the fifth embodiment are denoted by the same reference numerals.

In the sixth embodiment as shown in FIG. 10, the inner caliper half body 37 is provided with a mounting portion 82E approximately identical with the mounting portion 82D of the fifth embodiment. Different points between the mounting portion 82E and the mounting portion 82D are as follows.

At a center portion of mounting portion 82E in a disk circumferential direction, a mounting boss portion 164 projecting to both sides in a disk axial direction is provided. On the mounting boss portion 164, a bolt seat portion 165 is provided on a side opposite to the disk 11, the bolt seat portion 165 being slightly deviated to a side opposite to the disk 11 relative to the connecting surface portion 152 and being orthogonal in a disk axial direction. Further, the mounting boss portion 164 is also provided with a retaining surface portion 166 on a side of the disk 11, the mounting boss portion 164 being coplanar with the retaining surface portions 158a, 158b. Still further, a bolt installation hole 167 is formed in a disk axial direction so as to connect the bolt seat portion 165 with the retaining surface portion 166 at their centers.

Also, in the sixth embodiment, an integral molding tie bar (reinforcement member) 100E made of iron (cast iron or steel) is supported by the mounting portion 82E of the integral molding inner caliper half body 37 made of aluminum alloy.

The tie bar 100E of the sixth embodiment is slightly different from the tie bar 100D of the fifth embodiment. Their differences are as follows.

In the tie bar 100E, at the center portion of the tie bar portion 163 in a disk circumferential direction, the tie bar portion 163 connecting the adaptor portion 161a with the adaptor portion 161b, an engaging internal thread portion 168 is penetrated in a disk axial direction.

Here, the length of the tie bar 100E in a disk circumferential direction is set to be smaller than the distance between the retaining wall portions 156a, 156b of the mounting portion 82E, the tie bar 100E being loosely fitted into the retaining concave portion 155 of the mounting portion 82E.

In the tie bar 100E as discussed above, the tie bar 100E is supported by the caliper 13 prior to installment of the caliper 13 to a vehicle side. Then, the tie bar 100E is arranged within the retaining concave portion 155 of the mounting portion 82E so as to abut to the retaining surface portions 158a, 158b and the retaining surface portion 166. In a condition where the bolt installation hole 167 of the mounting portion 82E and the engaging internal thread portion 168 of the tie bar 100E is positionally adjusted, an axial portion 171 of a retaining bolt (engagement member, screw member) 170 is inserted from a side of the mounting portion 82E to the bolt installation hole 167. The axial portion 171 of the retaining bolt 170 is screwed into the engaging internal thread portion 168 of the tie bar 100E by means of an external thread 172. Here, fastening of a head 173 of the retaining bolt 170 is performed within tolerance that the tie bar 100E is not slipped off from the mounting portion 82E and is allowed to rotate within the retaining concave portion 155. Here, in a condition that the tie bar 100E is supported by the mounting portion 82E and is abutted to the retaining surface portion 158a, 158b of the mounting portion 82E of the caliper 13, the installation hole 160a of the mounting portion 82E of the caliper 13 is capable of being coincident with the internal thread portion 162a of the tie bar 100E while the installation hole 160b of the mounting portion 82E of the caliper 13 is also capable of being coincident with the internal thread portion 162b of the tie bar 100E.

In case that the caliper 13 is assembled to a vehicle, as discussed hereinabove, in a condition where the tie bar 100E is supported by the mounting portion 82E of the caliper 13 in advance, the abutting surface portion 151a on a side opposite to the tie bar 100E of the mounting portion 82E of the caliper 13 is abutted to the first surface 31a of the mounting projection 22a of the knuckle 14 while the abutting surface portion 151b is abutted to the first surface 31b of the mounting projection 22b of the knuckle 14. Then, by positionally adjusting the installation hole 160a of the mounting portion 82E to the installation hole 33a of the knuckle 14, the axial portion 115a of the fixing bolt 114a is inserted into the installation hole 33a from a side opposite to the disk 11. After the axial portion 115a of the fixing bolt 114a is inserted into the installation hole 160a of the caliper 13, the exterior thread 116a is screwed into the internal thread portion 162a of the adaptor portion 161a of the tie bar 100D. Here, if necessary, the tie bar 100E may be rotated so as to positionally adjust the internal thread portion 162a to the installation hole 160a. In the same manner, by positionally adjusting the installation hole 160b of the mounting portion 82E to the installation hole 33b of the knuckle 14, the axial portion 115b of the fixing bolt 114b is inserted into the installation hole 33b from a side opposite to the disk 11. After the axial portion 115b of the fixing bolt 114b is inserted into the installation hole 160b of the caliper 13, the exterior thread 116b is screwed into the internal thread portion 162b of the adaptor portion 161b of the tie bar 100E. Finally, the head 117a of the fixing bolt 114a and the head 117b of the fixing bolt 114b are fastened while the head 173 of the retaining bolt 170 is also fastened.

Accordingly, as the same with the fifth embodiment, the mounting portion 82E of the caliper 13 and the knuckle 14 are fastened by means of the tie bar 100E and the two fixing bolts 114a, 114b.

In the sixth embodiment, since the tie bar 100E approximately identical with the fifth embodiment is installed to the mounting portion 82E of the caliper 13, effects nearly the same with the fifth embodiment are obtainable. Further, even if supporting of the tie bar 100E to the mounting portion 82E is slightly different from the fifth embodiment, only the retaining bolt 170 will be the part to be required. Thus, in a condition that two adaptor portions 161a, 161b are both loosely fitted into the mounting portion 82E, the retaining bolt 170 can be screwed into the engaging internal thread portion 168 so as to support the tie bar 100E with the mounting portion 82E. Accordingly, a length of the tie bar 100E and a length between the retaining wall portions 156a, 156b can be easily managed.

Further, since the tie bar 100E can be supported by the mounting portion 82E by means of the retaining bolt 170, additional modification is only to provide the bolt installation hole 167 and the engaging internal thread portion 168 to the mounting portion 82E and the tie bar 100E, respectively thereby being able to reduce cost.

Still further, since the tie bar 100E can be supported by the mounting portion 82E not only by the fixing bolts 114a, 114b but also by the retaining bolt 170, the tie bar 100E can be connected with the mounting portion 82E at three portions, whereby rigidity as a whole is improved so as to further reduce brake noise.

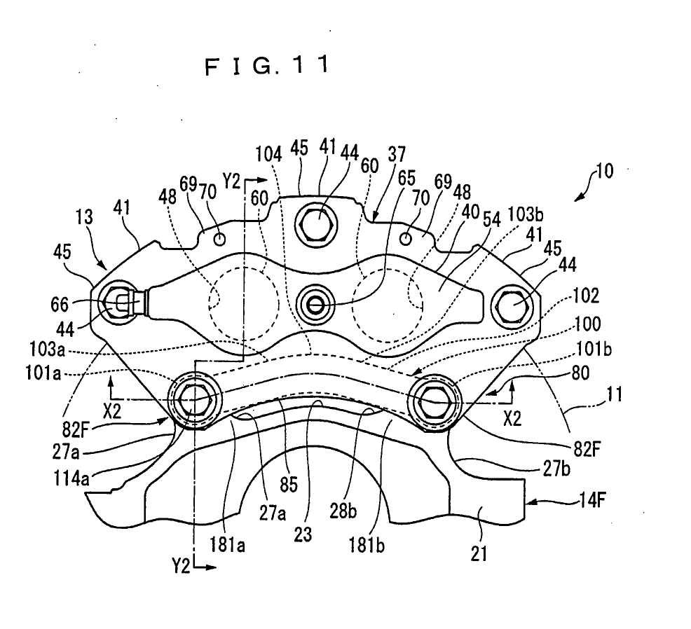

Next, a seventh embodiment of the present invention will be discussed with reference to FIGS. 11 to 13. The discussion will be mainly differences from the first embodiment.

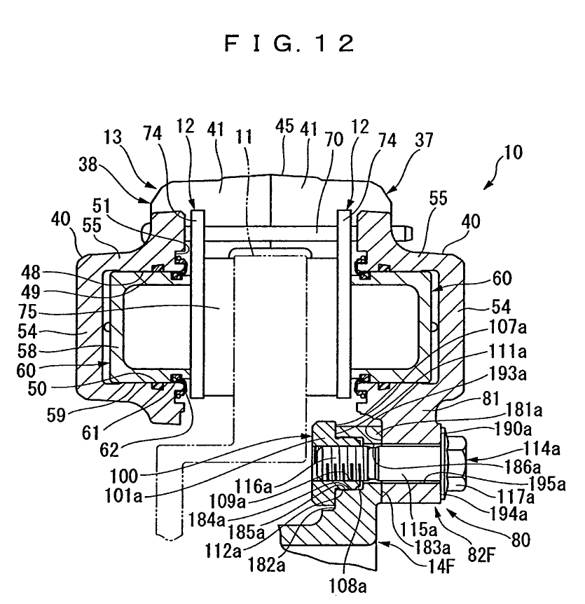

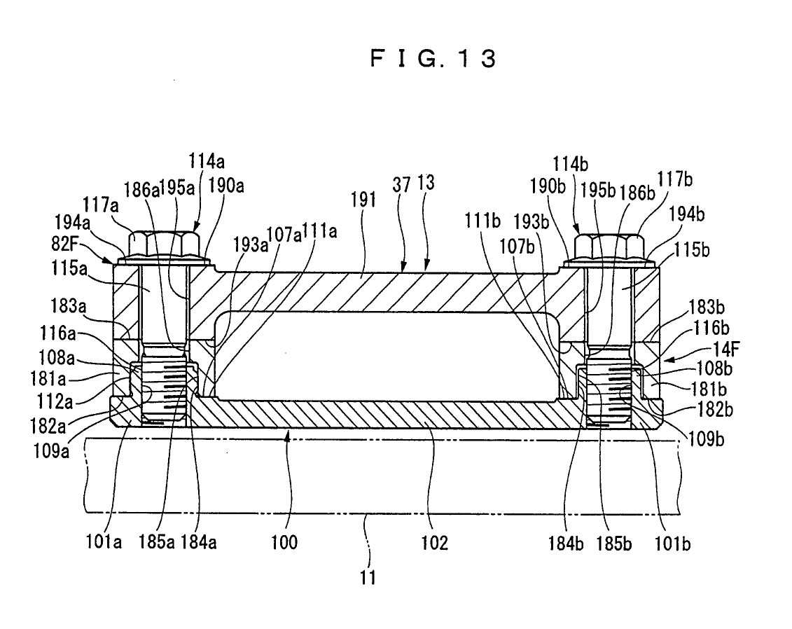

FIG. 11 is a front view of a disk brake according to the seventh embodiment of the present invention. FIG. 12 is a cross-sectional view of the disk brake according to the seventh embodiment of the present invention, which is taken along a line Y2-Y2 as shown in FIG. 11. FIG. 13 is a cross-sectional view of the disk brake according to the seventh embodiment of the present invention, which is taken along a line X2-X2 as shown in FIG. 11. Any component parts corresponding to those in the first embodiment are denoted by the same reference numerals.

In the seventh embodiment, the integral molding tie bar 100 according to the first embodiment (the tie bar 100 being made of iron such as cast iron or steel) is not supported by a mounting portion 82F of the integral molding inner caliper half body 37 made of aluminum alloy but supported by a knuckle 14F also made of aluminum alloy.

In the seventh embodiment, the knuckle 14F is provided with mounting projection portions 181a and 181b on a marginal portion of the base portion 21, the mounting projection portions 181a and 181b being placed separately in a disk circumferential direction and projecting outward in a disk radius direction.

The mounting projection portion 181a placed on one side in a disk circumferential direction is, as shown in FIGS. 12 and 13, provided with a surface portion 182a on a side of the disk 11 in a direction orthogonal to the disk axis and a surface portion 183a on a side opposite to the disk 11 in a direction orthogonal to the disk 11. An installation hole (a second installation hole) 184a is formed so as to penetrate in a disk axis direction, whereby the surface portions 182a and 183a are connected through their center portions. The installation hole 184a is provided with a recess 185a circular in its cross section. In the recess 185a, the side of the disk 11 is capable of being concaved to a side opposite to the disk 11. On a side opposite to the disk 11, the installation hole 184a is provided with a penetrated hole 186a that is penetrated into the center of the recess 185a, the penetrated hole 186a having a diameter smaller than the one of the recess 185a. Accordingly, the installation hole 184a is formed with steps.

As shown in FIG. 13, the mounting projection portion 181b on the other side in a disk circumferential direction is provided with: a surface portion 182b provided on a side of the disk 11, the surface portion 182b being coplanar with the surface portion 182a; and a surface portion 183b on a side opposite to the disk 11, the surface portion 183b being coplanar with the surface portion 183a. An installation hole (a second installation hole) 184b is formed so as to penetrate in a disk axis direction, whereby the surface portions 182b and 183b are connected through their center portions. The installation hole 184b is formed so as to be identical with the installation hole 184a. That is, the installation hole 184b is provided with a recess 185b circular in its cross section. In the recess 185b, the side of the disk 11 is capable of being concaved to a side opposite to the disk 11. On a side opposite to the disk 11, the installation hole 184b is provided with a penetrated hole 186b that is penetrated into the center of the recess 185b, the penetrated hole 186b having a diameter smaller than the one of the recess 185b. Accordingly, the installation hole 184b is formed with steps.

As shown in FIG. 12, on a side where the integral-molding, aluminum alloy inner caliper half body 37 of the caliper 13 is provided (right side in FIG. 12), the mounting portion 82F that is installed to a vehicle is extended from an intermediate portion of the cylinder portion 40 in an axial direction to a center of the disk 11.

As shown in FIG. 13, the mounting portion 82F is formed in a symmetrical manner and is provided with a pair of mounting boss portions 190a, 190b on both ends thereof in a disk circumferential direction, the mounting boss portions 190a, 190b projecting relative to an intermediate connecting portion 191 (explained hereinbelow) in a disk axial direction. According, between the mounting boss portions 190a, 190b of the mounting portion 82F, the intermediate connecting portion 191 is provided so as to connect these mounting boss portions 190a, 190b, the intermediate connecting portion 191 being slightly thinner than the mounting boss portions 190a, 190b in a disk axial direction.

The mounting boss portion 190a placed on one side in a disk circumferential direction is provided with a surface portion 193a on a side of the disk 11, the surface portion 193a being orthogonal in a disk axial direction and also provided with a surface portion 194a on a side opposite to the disk 11, the surface portion 194a being orthogonal in a disk axial direction. Further, an installation hole (a first installation hole) 195a is provided so as to penetrate in a disk axial direction, the installation hole 195a connecting the surface portion 193a with the surface portion 194a through their centers.

The mounting boss portion 190b placed on the other side in a disk circumferential direction is provided with a surface portion 193b on a side of the disk 11, the surface portion 193b being coplanar with the surface portion 193a and also provided with a surface portion 194b on a side opposite to the disk 11, the surface portion 194b being coplanar with the surface portion 194a. Further, an installation hole (a first installation hole) 195b is provided so as to penetrate in a disk axial direction, the installation hole 195b connecting the surface portion 193b with the surface portion 194b through their centers.

Here, in the seventh embodiment, the integral molding tie bar (reinforcement member) 100 according to the first embodiment, the tie bar 100 being made of iron such as cast iron or steel, is provided on a side opposite to the mounting portion 82F, that is, on a side of the disk 11.

In the tie bar 100, an external diameter of the projection portion 108a at the annular convex portion 112a of the adaptor portion 101a placed on side in a disk circumferential direction is set to be larger than an external diameter of the projection portion 108b of the adaptor portion 101b placed on the other side in a disk circumferential direction. Further, the external diameter of the projection portion 108a is set to be also larger than the recess 185a of the mounting projection portion 181a of the knuckle 14F for interference. On the other hand, the external diameter of the projection portion 108b of the adaptor portion 101b is set to be slightly smaller than the recess 185b of the mounting projection portion 181b of the knuckle 14F. Still further, a center distance between the projection portions 108a, 108b is set to be identical with a center distance between the recesses 185a, 185b.

The tie bar 100 is supported by the knuckle 14F before the caliper 13 is installed to a side of a vehicle. In this condition, the projection portions 108a, 108b are fastened to the recesses 185a, 185b of the installation holes 184a, 184b of the knuckle 14F. Here, the projection portion 108a of the adaptor portion 101a is pressed into the recess 185a so as to fasten to each other while the projection portion 108b of the adaptor portion 101b is loosely fitted to the recess 185b. Since the projection portion 108a of the adaptor portion 101a is press-fitted into the recess 185a, the tie bar 100 is adapted to be supported by the knuckle 14F. Also, in a condition where the tie bar 100 is fastened to and supported by the knuckle 14F by means of the adaptor portion 101a, the surface portion 111a of the mounting seat 107a of the tie bar 100 is adapted to abut to the surface portion 182a of the mounting projection portion 181a of the knuckle 14F. Accordingly, the surface portion 111b of the mounting seat 107b is adapted to abut the surface portion 182b of the mounting projection portion 181b. Further, in this condition, the installation hole 184a of the mounting projection portion 181a of the knuckle 14F and the internal thread portion 109a of the tie bar 100 are coincident to each other, that is, arranged to be coaxial. Still further, the installation hole 184b of the mounting projection portion 181b of the knuckle 14F and the internal thread portion 109b of the tie bar 100 are coincident to each other, that is, arranged to be coaxial.

When the caliper 13 is installed to a vehicle, as described above, in a condition where the tie bar 100 is supported by the knuckle 14F in advance, the surface portion 193a of the mounting boss portion 190a of the mounting portion 82F of the caliper 13 is abutted to the surface portion 183a of the mounting projection portion 181a of the knuckle 14F. Moreover, the surface portion 193b of the mounting boss portion 190b is abutted to the surface portion 183b of the mounting projection portion 181b of the knuckle 14F. Then, by positionally adjusting the installation hole 195a of the mounting portion 82F to the installation hole 184a of the knuckle 14F, the axial portion 115a of the fixing bolt 114a is installed into the installation hole 195a from a side opposite to the disk 11, and the axial portion 115a of the fixing bolt 114a is inserted into the penetrated hole 186a of the installation hole 184a of the knuckle 14F. The exterior thread 116a is then screwed into the internal thread portion 109a of the adaptor portion 101a of the tie bar 100. As the same with the above, by positionally adjusting the installation hole 195b of the mounting portion 82F to the installation hole 184b of the knuckle 14F, the axial portion 115b of the fixing bolt 114b is installed into the installation hole 195b from a side opposite to the disk 11, and the axial portion 115b of the fixing bolt 114b is inserted into the penetrated hole 186b of the installation hole 184b of the knuckle 14F. The exterior thread 116b is then screwed into the internal thread portion 109b of the adaptor portion 101b of the tie bar 100. Finally, the head 117a of the fixing bolt 114a as well as the head 117b of the fixing bolt 114b are fastened accordingly.

Based on the above, the head 117a of the fixing bolt 114a is abutted to the surface portion 194a of the mounting boss portion 190a of the mounting portion 82F of the caliper 13, the surface portion 193a of the mounting boss portion 190a is abutted to the surface portion 183a of the mounting projection portion 181a of the knuckle 14, the surface portion 182a of the mounting projection portion 181a of the knuckle 14F is abutted to the surface portion 111a of the mounting seat 107a of the tie bar 100, the head 117b of the fixing bolt 114b is abutted to the surface portion 194b of the mounting boss portion 190b of the mounting portion 82F of the caliper 13, the surface portion 193b of the mounting boss portion 190b is abutted to the surface portion 183b of the mounting projection portion 181b of the knuckle 14F, and the surface portion 182b of the mounting projection portion 181b of the knuckle 14F is abutted to the surface portion 111b of the mounting seat 107b of the tie bar 100. Accordingly, the mounting portion 82F of the caliper 13 and the knuckle 14F are fastened to each other by means of the tie bar 100 and two fixing bolts 114a, 114b.

In the above condition, the tie bar 100 is placed opposite to the mounting portion 82F and is provided at, or specifically is fastened to the mounting projection portions 181a, 181b. Here, the tie bar 100 is integrally formed with the mounting projection portions 181a, 181b as to connect the mounting projections 22a, 22b of the knuckle 14F in a disk circumferential direction, whereby the knuckle 14F is reinforced by the fixing bolts 114a, 114b.

In the seventh embodiment discussed hereinabove, there is provided the tie bar 100 that is placed opposite to the mounting portion 82F of the caliper 13 and is fastened to the knuckle 14F, the tie bar 100 comprising: the adaptor portion 101a provided with the internal threat portion 109a into which the fixing bolt 114a is screwed; the adaptor portion 101b provided with the internal thread portion 109b into which the fixing bolt 114b is screwed; and the tie bar portion 102 connecting the adaptor portions 101a, 101b. The tie bar 100 is made of iron with Young's modulus higher than the mounting portion 82F of the caliper 13 and the knuckle 14F each made of aluminum alloy, the tie bar 100 being fastened to and supported by the knuckle 14F by means of the adaptor portion 101a. Then, the exterior thread 116a of the fixing bolt 114a that is inserted into the installation hole 195a of the mounting portion 82F of the caliper 13 as well as the penetrated hole 186a of the installation hole 184a of the knuckle 14F is screwed into the internal thread portion 109a of the tie bar 100. In the same manner, the exterior thread 116b of the fixing bolt 114b that is inserted into the installation hole 195b of the mounting portion 82F of the caliper 13 as well as the penetrated hole 186b of the installation hole 184b of the knuckle 14F is screwed into the internal thread portion 109b of the tie bar 100. Accordingly, the mounting portion 82F of the caliper 13 and the knuckle 14F are fastened to each other by means of the fixing bolts 114a, 114b and the tie bar 100, whereby it is possible for the tie bar 100 to obtain functions of adaptor. Mounting operations of the tie bar 100 to the knuckle 14F can be thus facilitated while parts and cost can be reduced.

Since the tie bar 100 is fastened to and supported by the knuckle 14F by means of the adaptor portion 101a, the tie bar 100 can be installed to the knuckle 14F in advance.

Further, since the tie bar 100 is fastened to the knuckle 14F with the adaptor portions 101a, 101b, and these adaptor portions 101a, 101b are connected by the tie bar portion 102, it is possible to prevent the adaptor portions 101a, 101b from conducting simultaneous bolt-nut rotations when the fixing bolts 114a, 114b are screwed. Accordingly, mounting operations of the caliper 13 to the knuckle 14F can be facilitated.

Still further, before being fastened to the caliper 13 and the knuckle 14F by means of the fixing bolts 114a, 114b, the tie bar 100 is first supported by the knuckle 14F by making the internal thread portion 109a and the installation hole 184a being coincident with each other, and also by making the internal thread portion 109b and the installation hole 184b being coincident with each other. Accordingly, the fixing bolt 114a can be screwed into the internal thread portion 109a by inserting the fixing bolt 114a into the penetrate hole 186a of the installation hole 184a from a side of the mounting portion 82F. In the same manner, the fixing bolt 114b can be screwed into the internal thread portion 109b by inserting the fixing bolt 114b into the penetrated hole 186b of the installation hole 184b from a side of the mounting portion 82F. Screwing operations of the fixing bolts 114a, 114b to the tie bar 100 can be thus facilitated. Consequently, mounting operation of the caliper 13 to the knuckle 14F can be further eased.

Moreover, since the tie bar 100 is fastened to and supported by the knuckle 14F, any exclusive equipment to support the tie bar 100 is not necessary, whereby part and cost can be further reduced.

In addition, the mounting projection portions 181a, 181b of the knuckle 14F are each provided with the recesses 185a, 185b while the tie bar 100 is provided with the projection portions 108a, 108b that are adapted to be fastened to the recesses 185a, 185b respectively. Further, since the internal thread portion 109a is formed on the projection portion 108a while the internal thread portion 109b is formed on the projection portion 108b, each length of the internal thread portions 109a, 109b can be secured. Accordingly, axial force to screw the fixing bolts 114a, 114b can be further enhanced.

Further, in the tie bar 100, the adaptor portions 101a, 101b are each provided with the projection portions 108a, 108b, and the projection portion 108a of the adaptor portion 101a is press-fitted to the recess 185a of the knuckle 14F so as to make the tie bar 100 retained by the knuckle 14F. Accordingly, supporting operations of the tie bar 100 to the knuckle 14F is facilitated, and since any exclusive equipment to support the tie bar 100 is not required, parts can be further reduced.

When the tie bar 100 is supported by the knuckle 14F with the adaptor portions 101a, 101b, the projection portion 108a of the adaptor portion 101a is press-fitted into the recess 185a of the knuckle 14F while the projection portion 108b of the adaptor portion 101b is loosely fitted to the recess 185b of the knuckle 14F. Accordingly, since only one of the adaptors is required to be press-fitted, supporting operations of the tie bar 100 to the knuckle 14F are further facilitated, and tolerance between the projection portions 108a, 108b can be well absorbed.

Also, in the seventh embodiment, only one pair of the installation holes 195a, 195b of the mounting portion 82F of the caliper 13 may be enough. Further, the number of the installation holes 184a, 184b of the knuckle 14F, the number of the adaptor portions 101a, 101b of the tie bar 100, and the number of the internal thread portions 109a, 109b of the tie bar 100 may also be at least two.

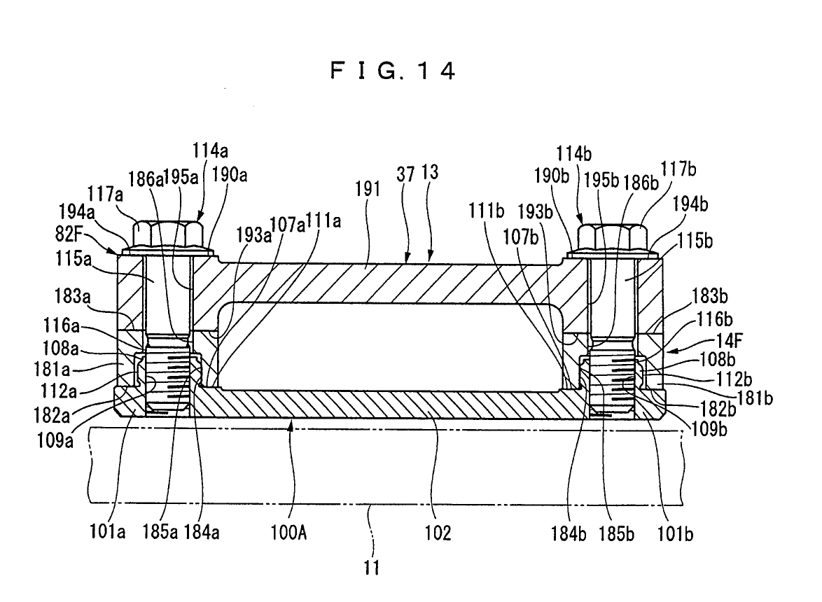

Next, an eighth embodiment of the present invention will be discussed with reference to FIG. 14. The discussion will be mainly differences from the seventh embodiment.

FIG. 14 is a cross-sectional view of a disk brake according to the eighth embodiment of the present invention, which is taken along a line X2-X2 as shown in FIG. 11. Any component parts corresponding to those in the seventh embodiment are denoted by the same reference numerals.

In the eighth embodiment as shown in FIG. 14, compared to the knuckle 14F of the seventh embodiment, the tie bar 100A of the second embodiment as shown in FIG. 4 is installed, the tie bar 100A being provided with the projection portion 108a with the annular convex portion 112a and the projection portion 108b with the annular convex portion 112b. The projection portions 108a, 108b are both identical in their diameters. Accordingly, external diameters of the projection portions 108a, 108b are set to be slightly smaller than inner diameters of the recesses 185a, 185b while a center distance between the projection portions 108a, 108b is set to be shorter than a center distance between the recesses 185a, 185b.

Accordingly, in the tie bar 100A, the annular convex portions 112a, 112b of the projection portions 108a, 108b pinch walls of the recesses 185a, 185b from both sides thereof, whereby the tie bar 100A will be fastened to and supported by the knuckle 14F.

In the eighth embodiment, the tie bar 100A that is approximately the same with the seventh embodiment is installed to the knuckle 14F, whereby effects approximately the same with the seventh embodiment are obtainable. Further, as to the supporting method of the tie bar 100A to the mounting portion 82F, the tie bar 100A has two adaptor portions 101a, 101b that are provided with two projection portions 108a, 108b. The tie bar 100A is fastened to the knuckle 14F in such a manner that the projection portions 108a, 108b are adapted to pinch the wall surfaces of the recesses 185a, 185b from the both sides thereof. Accordingly, as the same with the seventh embodiment, supporting operations of the tie bar 100A to the knuckle 14F will be facilitated.

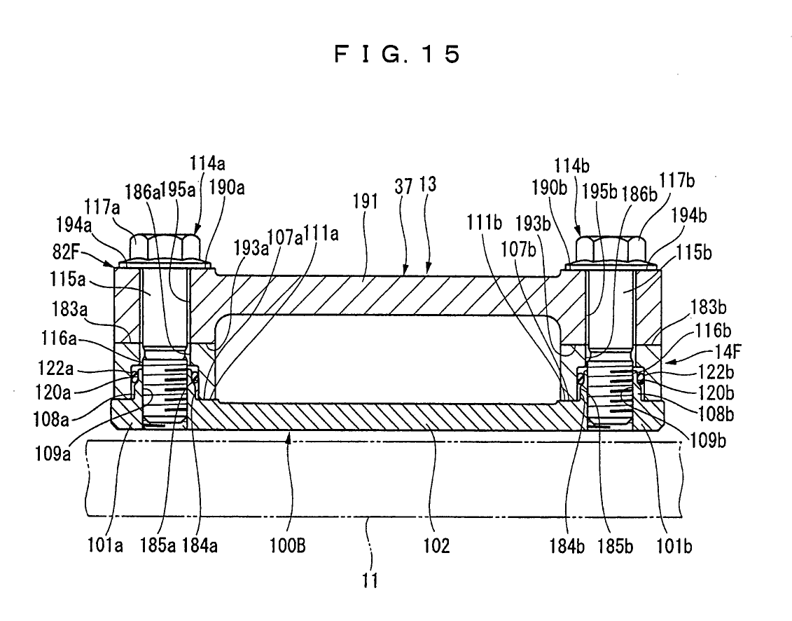

Next, a ninth embodiment of the present invention will be discussed with reference to FIG. 15. The discussion will be mainly differences from the seventh embodiment.

FIG. 15 is a cross-sectional view of a disk brake according to the ninth embodiment of the present invention, which is taken along a line X2-X2 as shown in FIG. 11. Any component parts corresponding to those in the seventh embodiment are denoted by the same reference numerals.

In the ninth embodiment as shown in FIG. 15, the tie bar 100B according to the third embodiment as shown in FIG. 5 is installed to the knuckle 14F. The tie bar 100B is, as discussed hereinbefore, provided with the annular notch portion 120a on the tip external diameter of the projection portion 108a, the notch portion 120a being formed up to the end of the projection portion 108a as well as the annular notch portion 120b on the tip external diameter of the projection portion 108b, the notch portion 120b being formed up to the end of the projection portion 108b. As the same with the third embodiment, the O-ring 122a is provided on the notch portion 120a of the projection portion 108a while the O-ring 122b is provided on the notch portion 120b of the projection portion 108b. Further, the external diameters of the projection portions 108a, 108b are set to be slightly smaller than the inner diameters of the recesses 185a, 185b of the knuckle 14F. Still further, the inner diameter of the recess 185a is set to be slightly smaller than the external diameter of the O-ring 122a supported by the notch portion 120a of the projection portion 108a. In the same manner, the inner diameter of the recess 185b is set to be slightly smaller than the external diameter of the O-ring 122b supported by the notch portion 120b of the projection portion 108b. In addition, a center distance between the projection portions 108a, 108b is set to be identical with a center distance between the recesses 185a, 185b.

Accordingly, by fastening the projection portion 108a of the tie bar 100B to the recess 185a of the knuckle 14, and in the same manner, by fastening the projection portion 108b to the recess 185b, the O-ring 122a is tightly fastened to the wall surface of the recess 185a by the diameter difference described hereinabove, the O-ring 122a being pressed in a radius direction. The O-ring 122a thus intervenes between the projection portion 108a and the recess 185a. In the same manner, the O-ring 122b is tightly fastened to the wall surface of the recess 185b by the diameter difference described hereinabove, the O-ring 122b being pressed in a radius direction. The O-ring 122b thus intervenes between the projection portion 108b and the recess 185b. With elastic force and frictional force generated hereinabove, the tie bar 100B is supported by the knuckle 14F.

In the ninth embodiment as discussed hereinabove, since the tie bar 100B approximately identical with the seventh embodiment is installed to the knuckle 14F, it is possible to obtain effects almost the same with the seventh embodiment.

Further, as to the supporting method of the tie bar 100B to the mounting portion 82F that is different from the seventh embodiment, the O-ring 122a provided at the projection portion 108a of the tie bar 100B is adapted to intervene between the projection portion 108a and the recess 185a. In the same manner, the O-ring 122b provided at the projection portion 108b is adapted to intervene between the projection portion 108b and recess 185b. The tie bar 100B is thus supported by the knuckle 14F. Accordingly, as the same with the seventh embodiment, supporting operations of the tie bar 100B to the knuckle 14F will be facilitated. Further it makes possible that the tie bar 100B can be manually retained to the knuckle 14F, whereby no additional equipment for press-fitting the tie bar 100B to the knuckle 14F will be needed.

Here, in the tie bar 100B of the ninth embodiment, instead of the notch portions 120a, 120b, it is of course possible to form the annular seal groove 124b as shown in FIG. 7 where the O-ring 122b is not slipped off from the top of the projection portion, and the O-ring 122b is fastened on the annular seal groove 124b.

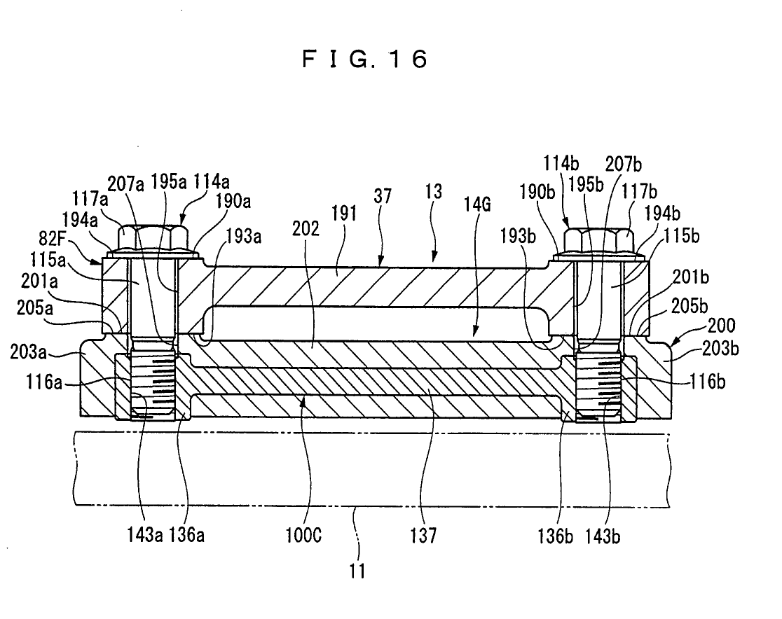

Next, a tenth embodiment of the present invention will be discussed with reference to the FIG. 16. The discussion will be mainly differences from the seventh embodiment.

FIG. 16 is a cross-sectional view of a disk brake according to the tenth embodiment of the present invention, which is taken along a line X2-X2 as shown in FIG. 11. Any component parts corresponding to those in the seventh embodiment are denoted by the same reference numerals.

In the tenth embodiment as shown in FIG. 16, compared to the seventh embodiment, the symmetrically formed tie bar 100C according to the fourth embodiment as shown in FIG. 8 is molded into a knuckle 14G made of aluminum alloy when die-cast molded.

The knuckle 14G is provided with a mounting portion 200 on the marginal portion thereof in a disk radius direction, the mounting portion 200 extending in a disk radius direction.

The mounting portion 200 is formed in a symmetrical manner, and provided with a pair of mounting boss portion 201a and mounting boss portion 201b on both ends thereof in a disk circumferential direction, the mounting boss portions 201a, 201b projecting to a side opposite to the disk 11 in a disk axial direction. Further, the mounting portion 200 is provided with an intermediate connecting portion 202 so as to connect the mounting boss portions 201a, 201b, the intermediate connecting portion 202 being slightly thinner than the mounting boss portions 201a, 201b in a disk axial direction. Still further, the mounting portion 200 is also provided with a distal formation portion 203a on the mounting boss portion 201a (on a side opposite to the mounting boss portion 201b), the distal formation portion 203a being slightly thinner than the mounting boss portion 201a in a disk axial direction. In the same manner, on the mounting boss portion 201b (on a side opposite to the mounting boss portion 201a), a distal formation portion 203b that is slightly thinner than the mounting boss portion 201b in a disk axial direction is provided.

At the mounting boss portion 201a placed on one side in a disk circumferential direction, a surface portion 205a is provided on a side opposite to the disk 11, the surface portion 205a being orthogonal to a disk axis. In the same manner, at the mounting boss portion 201b on the other side in a disk circumferential direction, a surface portion 205b is formed so as to be coplanar with the surface portion 205a.

The tie bar 100C is molded into the mounting portion 200, the tie bar 100C being slightly deviated to a side of the disk 11. Accordingly, an end of the adaptor portion 136a on a side of the disk 11 projects beyond the mounting portion 200 to a side of the disk 11 while an end of the adaptor portion 136a on a side opposite to the disk 11 is arranged within the mounting portion 200. Further, the center of the adaptor portion 136a is coincident with the center of the mounting boss portion 201a of the mounting portion 200. In the same manner, an end of the adaptor portion 136b on a side of the disk 11 projects beyond the mounting portion 200 to a side of the disk 11 while an end of the adaptor portion 136b on a side opposite to the disk 11 is arranged within the mounting portion 200. Further, the center of the adaptor portion 136b is coincident with the center of the mounting boss portion 201b of the mounting portion 200.

An installation hole (a second installation hole) 207a is formed in a disk axial direction from the center position of the surface portion 205a of the mounting boss portion 201a of the mounting portion 200 to the adaptor portion 136a. Further, the adaptor portion 136a is provided with the internal thread portion 143a at the center portion thereof so as to penetrate in a disk axial direction, the internal thread portion 143a being connected with the installation hole 207a. The adaptor portion 136a and the internal thread portion 143a are adapted to be coincident with the center of the mounting boss portion 201a. The installation hole 207a and the internal thread portion 143a are formed in a condition that the tie bar 100C has been molded into the mounting portion 200.

In the same manner with the above, an installation hole (a second installation hole) 207b is formed in a disk axial direction from the center position of the surface portion 205b of the mounting boss portion 201b of the mounting portion 200 to the adaptor portion 136b. Further, the adaptor portion 136b is provided with the internal thread portion 143b at the center portion thereof so as to penetrate in a disk axial direction, the internal thread portion 143b being connected with the installation hole 207b. The adaptor portion 136b and the internal thread portion 143b are also adapted to be coincident with the center of the mounting boss portion 201b. The installation hole 207b and the internal thread portion 143b are formed in a condition that the tie bar 100C has been molded into the mounting portion 200.

When the caliper 13 is installed to a vehicle, the surface portion 193a of the mounting boss portion 190a of the mounting portion 82F of the caliper 13 is abutted to the surface portion 205a of the mounting boss portion 201a of the mounting portion 200 of the knuckle 14G where the tie bar 100C has been molded while the surface portion 193b of the mounting boss portion 190b of the mounting portion 82F of the caliper 13 is abutted to the surface portion 205b of the mounting boss portion 201b of the mounting portion 200 of the knuckle 14G.

Then, after the installation hole 195a of the mounting portion 82F is positionally adjusted to the installation hole 207a of the knuckle 14, the axial portion 115a of the fixing bolt 114a is inserted into the installation hole 195a from a side opposite to the disk 11. By inserting the axial portion 115a of the fixing bolt 114a into the installation hole 207a of the knuckle 14G, the exterior thread 116a is screwed into the internal thread portion 143a of the adaptor portion 136a of the tie bar 100C. In the same manner, after the installation hole 195b of the mounting portion 82F is positionally adjusted to the installation hole 207b of the knuckle 14G, the axial portion 115b of the fixing bolt 114b is inserted into the installation hole 195b from a side opposite to the disk 11. By inserting the axial portion 115b of the fixing bolt 114b into the installation hole 207b of the knuckle 14G, the external thread 116b is screwed into the internal thread portion 143b of the adaptor portion 136b of the tie bar 100C. Finally, the head 117a of the fixing bolt 114a and the head 117b of the fixing bolt 114b are fastened.

Based on the above, the head 117a of the fixing bolt 114a is abutted to the surface portion 194a of the mounting boss portion 190a of the mounting portion 82F, the surface portion 193a of the mounting boss portion 190a is abutted to the surface portion 205a of the mounting boss portion 201a of the mounting portion 200 of the knuckle 14G, the head 117b of the fixing bolt 114b is abutted to the surface portion 194b of the mounting boss portion 190b of the mounting portion 82F, and the surface portion 193b of the mounting boss portion 190b is abutted to surface portion 205b of the mounting boss portion 201b of the mounting portion 200 of the knuckle 14F. The mounting portion 82F of the caliper 13 and the knuckle 14G are then fastened to each other by means of the tie bar 100C and the fixing bolts 114a, 114b. That is, the caliper 13 is installed to a vehicle.

In the above condition, the tie bar 100C is placed on a side opposite to the mounting portion 82F and installed to, or more specifically integrally molded to the mounting portion 200 of the knuckle 14G. Further, in this condition, the tie bar 100C is integrally formed with the mounting portion 200 so as to connect the mounting boss portions 201a, 201b of the knuckle 14G in a disk circumferential direction while the knuckle 14G is reinforced by the fixing bolts 114a, 114b.

In the tenth embodiment discussed hereinabove, there is provided the tie bar 100C comprising: the adaptor portion 136a molded into the mounting portion 200 of the knuckle 14G on a side of the disk 11, the adaptor portion 136a being provided with the internal thread portion 143a into which the fixing bolt 114a is screwed; the adaptor portion 136b molded into the mounting portion 200 of the knuckle 14G on a side of the disk 11, the adaptor portion 136b being provided with the internal thread portion 143b into which the fixing bolt 114b is screwed; and the tie bar 137 connecting the adaptor portions 136a, 136b. The tie bar 100C is made of iron having Young's modulus higher than the mounting portion 82F and the knuckle 14G each made of aluminum alloy, the tie bar 100C being molded into and supported by the mounting portion 200 of the knuckle 14G. Accordingly, the exterior thread 116a of the fixing bolt 114a inserted into the installation hole 195a of the mounting portion 82F of the caliper 13 as well as the installation hole 207a of the mounting portion 200 of the knuckle 14G is screwed into the internal thread portion 143a of the tie bar 100C while the exterior thread 116b of the fixing bolt 114b inserted into the installation hole 195b of the mounting portion 82F of the caliper 13 as well as the installation hole 207b of the mounting portion 200 of the knuckle 14G is screwed into the internal thread portion 143b of the tie bar 100C. The mounting portion 82F of the caliper 13G and the knuckle 14G can be thus fastened to each other by means of the fixing bolts 114a, 114b and the tie bar 100C, whereby it is possible for the tie bar 100C to obtain functions of adaptor. Also, mounting operations of the tie bar 100C to the knuckle 14G are facilitated while parts and cost can be reduced.

Further, since the tie bar 100C is molded into and supported by the mounting portion 200 of the knuckle 14G, operations that the tie bar 100C is installed to the knuckle 14G will not be necessary. Accordingly, mounting operations of the caliper 13 to the knuckle 14G are further eased.

Still further, in the tie bar 100C, before the caliper 13 and the knuckle 14G are fastened to each other with the fixing bolts 114a, 114b, the internal thread portion 143a and the installation hole 207a are coincident with each other while the internal thread portion 143b and the installation hole 207b are coincident with each other. The tie bar 100C is thus supported by the knuckle 14G. Accordingly, it is possible that the fixing bolt 114a is screwed into the internal thread portion 143a by simply inserting the fixing bolt 114a from a side of the caliper 13 to the installation hole 207a. In the same manner, it is also possible that the fixing bolt 114b is screwed into the internal thread portion 143b by simply inserting the fixing bolt 114b from a side of the caliper 13 to the installation hole 207b. Screwing operations of the fixing bolts 114a, 114b to the tie bar 100C can be thus facilitated. Consequently, mounting operations of the caliper 13 to the knuckle 14G can be further eased.

Moreover, since the tie bar 100C is molded into and supported by the knuckle 14G, any exclusive equipment to support the tie bar 100C will not be necessary, whereby parts and cost can be further reduced.

Also, in the tenth embodiment, the number of the installation holes 195a, 195b of the mounting portion 82F of the caliper 13 may be only two (at least two). As the same, the number of the installation holes 207a, 207b of the knuckle 14G, the number of the adaptor portions 136a, 136b of the tie bar 100C, and the number of the internal thread portions 143a, 143b of the tie bar 100C may also be at least two.

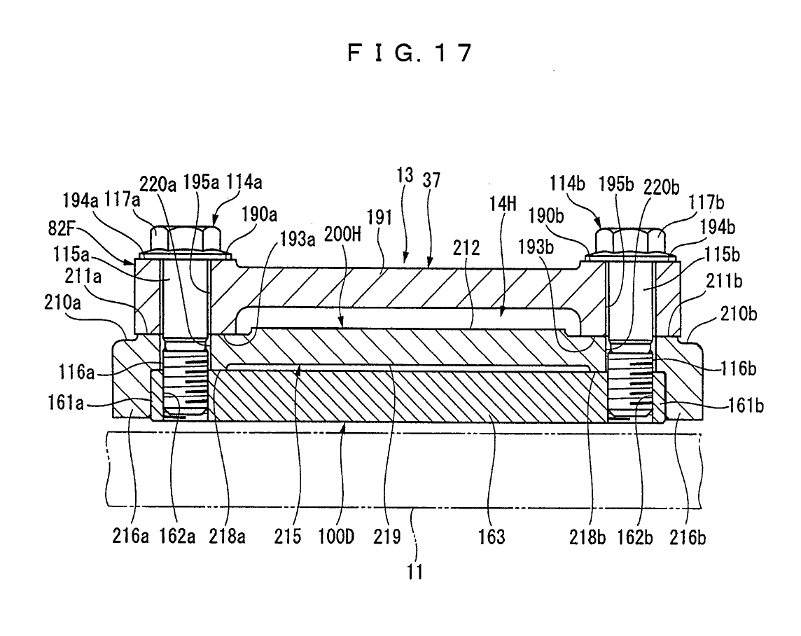

Next, an eleventh embodiment of the present invention will be discussed with reference to FIG. 17. The discussion will be mainly differences from the seventh embodiment.

FIG. 17 is a cross-sectional view of a disk brake according to the eleventh embodiment of the present invention, which is taken along a line X2-X2 as shown in FIG. 11. Any component parts corresponding to those in the seventh embodiment are denoted by the same reference numerals.

In the eleventh embodiment as shown in FIG. 17, compared to the seventh embodiment, the symmetrically formed tie bar 100D of the fifth embodiment as shown in FIG. 9 is applied, the tie bar 100D being formed into a plate constant in its thickness in a disk axial direction and comprising: the adaptor portion 161a with the internal thread portion 162a; the adaptor portion 161b with the internal thread portion 162b; and the tie bar portion 163 connecting the adaptor portions 161a, 161b.

Here, as shown in FIG. 17, an aluminum alloy knuckle 14H according to the eleventh embodiment is provided with a symmetrically formed mounting portion 200H on the marginal portion of the knuckle 14H in a disk radius direction, the mounting portion 200H projecting in a disk radius direction.

At the mounting portion 200H on a side opposite to the disk 11, stepped surfaces 210a, 210b are provided on both ends in a disk circumferential direction, the stepped surfaces 210a, 210b being orthogonal in a disk axial direction and being coplanar to each other. At portions inside of the both stepped surfaces 210a, 210b in a radius direction of the disk 11, abutting surface portions 211a, 211b are arranged so as to be coplanar to each other, the abutting surface portions 211a, 211b being deviated to a side opposite to the disk 11 relative to the stepped surfaces 210a, 210b and being orthogonal in a disk axial direction. Further, between the abutting surface portions 211a, 211b, a connecting surface portion 212 is provided so as to be orthogonal in a disk axial direction, the connecting surface portion 212 being deviated to a side opposite to the disk 11 relative to abutting surface portion 211a, 211b.

Furthermore, on the disk 11 side of the mounting portion 200H, a retaining concave portion 215 that extends in a disk circumferential direction is formed, the retaining concave portion 215 being able to concave to a side opposite to the disk 11. On the both ends in a disk circumferential direction, retaining wall portions 216a, 216b are provided, the retaining wall portions 216a, 216b projecting to a side of the disk 11 in a disk axial direction. On a bottom portion of the retaining concave portion 215 (both end sides thereof), a retaining surface portion 218a is provided on the disk 11 side of the abutting surface portion 211a so as to be orthogonal in a disk axial direction while a retaining surface portion 218b is provided on the disk 11 side of the abutting surface portion 211b so as to be orthogonal in a disk axial direction. Both the retaining surface portion 218a and the retaining surface portion 218b are arranged to be coplanar to each other. Still further, between the retaining surface portions 218a, 218b of the bottom portion of the retaining concave portion 215, a relief portion 219 is formed so as to be slightly deviated to a side opposite to the disk 11 relative to the retaining surface portions 218a, 218b, the relief portion 219 being orthogonal in a disk axial direction.

Here, on the mounting portion 200H, an installation hole (a second installation hole) 220a is provided so as to penetrate in a disk axial direction, the installation hole 220a being formed as that the abutting surface portion 211a and the retaining surface portion 218a both provided on one side in a disk circumferential direction are connected by each center thereof. In the same manner, an installation hole (a second installation hole) 220b is provided so as to penetrate in a disk axial direction, the installation hole 220b being formed as that the abutting surface portion 211b and the retaining surface portion 218b both provided on the other side in a disk circumferential direction are connected by each center thereof. In the eleventh embodiment, the mounting portion 200H is also formed in a symmetrical manner.

In the eleventh embodiment, the tie bar 100D according to the fifth embodiment as shown in FIG. 9, the tie bar 100D being formed into a plate constant in its thickness, is supported by the mounting portion 200H of the knuckle 14H. Here, the length of the tie bar 100D in a disk circumferential direction is set to be longer than the distance between the retaining wall portions 216a, 216b of the mounting portion 200H for interference.

Before the tie bar 100D of this type is installed to a vehicle side of the caliper 13, the tie bar 100D is supported within the retaining concave portion 215 of the mounting portion 200H of the knuckle 14H. Here, the adaptor portions 161a, 161b placed on both sides of the tie bar 100D in a longitudinal direction are placed between the retaining wall portions 216a, 216b of the mounting portion 200H with interference. Accordingly, the tie bar 100D is adapted to be supported by the mounting portion 200H of the knuckle 14H. In the above condition, the tie bar 100D is abutted to the retaining surface portions 218a, 218b of the mounting portion 200H of the knuckle 14H. Further, the installation hole 220a of the mounting portion 200H of the knuckle 14H is coincident with the internal thread portion 162a of the tie bar 100D while the installation hole 220b of the mounting portion 200H of the knuckle 14H is coincident with the internal thread portion 162b of the tie bar 100D.

When the caliper 13 installed to a vehicle, as discussed hereinabove, the tie bar 100D is supported by the mounting portion 200H of the knuckle 14H in advance. In this condition, the surface portion 193a of the mounting portion 82F of the caliper 13 on a side of the disk 11 is abutted to the abutting surface portion 211a of the mounting portion 200H of the knuckle 14H while the surface portion 193b of the mounting portion 82F on a side of the disk 11 is abutted to the abutting surface portion 211b of the mounting portion 200H of the knuckle 14H. Then, by positionally adjusting the installation hole 195a of the mounting portion 82F to the installation hole 220a of the knuckle 14H, the axial portion 115a of the fixing bolt 114a is inserted into the installation hole 195a from a side opposite to the disk 11 and is coincidentally inserted into the installation hole 220a of the knuckle 14H. Accordingly, the exterior thread 116a in screwed into the internal thread portion 162a of the adaptor portion 161a of the tie bar 100D. In the same manner, by positionally adjusting the installation hole 195b of the mounting portion 82F to the installation hole 220b of the knuckle 14H, the axial portion 115b of the fixing bolt 114b is inserted into the installation hole 195b from a side opposite to the disk 11 and is coincidentally inserted into the installation hole 220b of the knuckle 14H. Accordingly, the exterior thread 116b in screwed into the internal thread portion 162b of the adaptor portion 161b of the tie bar 100D. Finally, the head 117a of the fixing bolt 114a and the head 117b of the fixing bolt 114b are both fastened.

Accordingly, the head 117a of the fixing bolt 114a is abutted to the surface portion 194a of the mounting boss portion 190a of the caliper 13, the surface portion 193a of the mounting boss portion 190a is abutted to the abutting surface portion 211a of the knuckle 14H, the retaining surface portion 218a of the knuckle 14H is abutted to the tie bar 100D, the head 117b of the fixing bolt 114b is abutted to the surface portion 194b of the mounting boss portion 190b of the caliper 13, the surface portion 193b of the mounting boss portion 190b is abutted to the abutting surface portion 211b of the mounting portion 82F of the knuckle 14H, and the retaining surface portion 218b of the knuckle 14H is abutted to the tie bar 100D. The mounting portion 82F of the caliper 13 and the knuckle 14H are thus fastened to each other by means of the tie bar 100D and two fixing bolts 114a, 114b. That is, the caliper 13 is installed to a vehicle.

As discussed above, the tie bar 100D is installed to, or more specifically, is fastened to the mounting portion 200H of the knuckle 14H, the tie bar 100D being placed on a side opposite to the mounting portion 82F. Here, the tie bar 100D is integrally formed with the mounting portion 200H so as to being connected with the knuckle 14H in a disk circumferential direction, the knuckle 14H being reinforced with the fixing bolts 114a, 114b.

In the eleventh embodiment discussed hereinabove, the tie bar 100D is provided on a side opposite to the caliper 13, the tie bar 100D being fastened to the mounting portion 200H of the knuckle 14H. The tie bar 100D is provided with the internal thread portion 162a into which the fixing bolt 114a is screwed and the internal thread portion 162b into which the fixing bolt 114b is screwed, the tie bar 100D being made of iron having Young's modulus higher than the mounting portion 82F and the knuckle 14H each made of aluminum alloy. The tie bar 100D is fastened to and supported by the mounting portion 200H of the knuckle 14H by means of the adaptor portions 161a, 161b. The external thread 116a of the fixing bolt 114a inserted into the installation hole 195a of the caliper 13 as well as installation hole 220a of the knuckle 14H is screwed into the internal thread portion 162a of the adaptor portion 161a of the tie bar 100D. In the same manner, the external thread 116b of the fixing bolt 114b inserted into the installation hole 195b of the caliper 13 as well as installation hole 220b of the knuckle 14H is screwed into the internal thread portion 162b of the adaptor portion 161b of the tie bar 100D. Accordingly, the mounting portion 82F of the caliper 13 and the knuckle 14H are fastened to each other by means of the fixing bolts 114a, 114b and the tie bar 100D, whereby it is possible for the tie bar 100D to obtain functions of adaptor. Mounting operations of the tie bar 100D to the caliper 13 can be thus facilitated, and parts and cost can be reduced.

Further, since the tie bar 100D is fastened to and supported by the mounting portion 200H of the knuckle 14H by means of the adaptor portions 161a, 161b, the tie bar 100D can be installed to the knuckle 14H in advance.

Still further, in the tie bar 100D, before the caliper 13 and the knuckle 14H are fastened to each other by means of the fixing bolts 114a, 114b, the internal thread portion 162a of the adaptor portion 161a and the installation hole 220a are coincident to each other while the internal thread portion 162b of the adaptor portion 161b and the installation hole 220b are coincident to each other. Since the tie bar 100D is supported by the knuckle 14H in the above condition, the fixing bolt 114a can be screwed into the internal thread portion 162a by inserting the fixing bolt 114a into the installation hole 220a from a side of the caliper 13 while the fixing bolt 114b can be also screwed into the internal thread portion 162b by inserting the fixing bolt 114b into the installation hole 220b from a side of the caliper 13. Accordingly, the fixing bolts 114a, 114b can be easily screwed into the tie bar 100D. That is, mounting operations of the caliper 13 to the knuckle 14H can be further eased.

Moreover, since the tie bar 100D is fastened to and supported by the knuckle 14H by means of the adaptor portions 161a, 161b, any exclusive equipment to support the tie bar 100D is not necessary, whereby parts and cost can be further reduced.

In addition, the tie bar 100D is retained between the retaining wall portions 156a, 156b of the knuckle 14H through the adaptor portions 161a, 161b placed at both ends of the tie bar 100D in a longitudinal direction. Accordingly, it is possible for the tie bar 100D to be formed without any projections, etc. thereby being able to reduce manufacturing cost thereof.

In the eleventh embodiment also, the number of the installation holes 195a, 195b of the caliper 13 may also be only two (at least two). As the same, the number of the installation holes 220a, 220b of the mounting portion 200H of the knuckle 14H, the number of the adaptor portions 161a, 161b of the tie bar 100D, and the number of the internal thread portions 162a, 162b of the tie bar 100D may also be at least two.

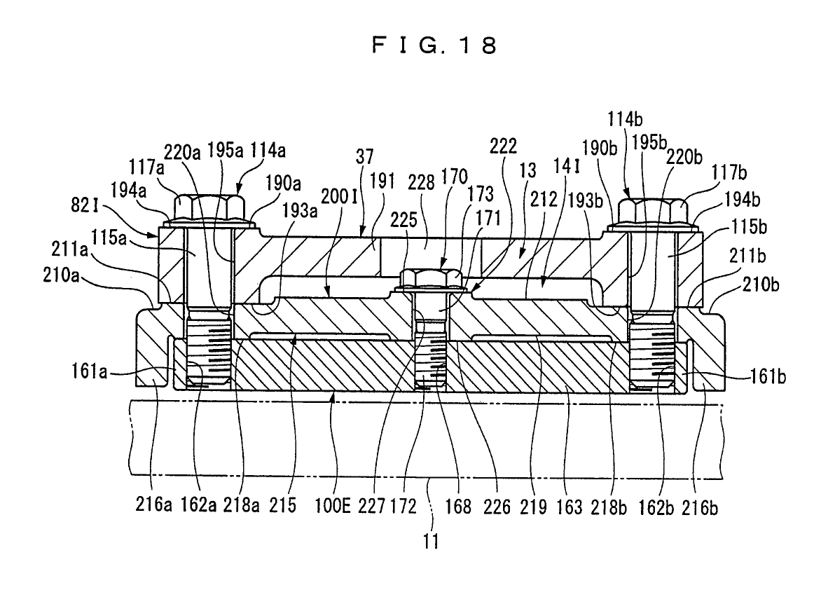

Lastly, a twelfth embodiment of the present invention will be explained according to FIG. 18. The discussion will be mainly differences from the eleventh embodiment.

FIG. 18 is a cross-sectional view of a disk brake according to the twelfth embodiment of the present invention, which is taken along a line X2-X2 as shown in FIG. 11. Any component parts corresponding to those in the eleventh embodiment are denoted by the same reference numerals.

In the twelfth embodiment according to FIG. 18, a mounting portion 200I of the knuckle 14I is slightly different from the mounting portion 200H of the eleventh embodiment as follows

The mounting portion 200I is provided with a mounting boss portion 222 at its center in a circumferential direction, the mounting boss portion 222 projecting on both sides in a disk axial direction. The mounting boss portion 222 is provided with a bolt seat portion 225 on a side opposite to the disk 11, the bolt seat portion 225 being slightly deviated to a side opposite to the disk 11 relative to the connecting surface portion 212 and being orthogonal in a disk axial direction. Further, the mounting boss portion 222 is also provided with a retaining surface portion 226 on a side of the disk 11, the retaining surface portion 226 being arranged to be coplanar with the retaining surface portions 218a, 218b. Still further, a bolt insertion hole 227 provided in a disk axial direction is formed so as to connect the bolt seat portion 225 with the retaining surface portion 226 at their centers.

In the twelfth embodiment, the tie bar 100E of the sixth embodiment as shown in FIG. 10 is supported by the mounting portion 200I of the knuckle 14I made of aluminum alloy. Here, the length of the tie bar 100E in a disk circumferential direction is set to be shorter than the distance between the retaining wall portions 216a, 216b of the mounting portion 200I, the tie bar 100E being loosely fitted within the retaining concave portion 215.

The mounting portion 82I of the caliper 13 is approximately identical with the mounting portion 82F of the eleventh embodiment, but compared to the mounting portion 82F of the eleventh embodiment, an escape groove 228 for installing the retaining bolt 170 is formed at the center portion of the intermediate connecting portion 191.

In the tie bar 100E as discussed hereinabove, before the caliper 13 is installed to the side of a vehicle, the tie bar 100E is supported by the knuckle 14I. In this condition, the tie bar 100E is arranged within the retaining concave portion 215 of the mounting portion 200I, the tie bar 100E being abutted to the retaining surface portions 218a, 218b as well as the retaining surface portion 226. Then, in a condition where the bolt insertion hole 227 of the mounting portion 200I is positionally adjusted to the engaging internal thread portion 168 of the tie bar 100E, the axial portion 171 of the retaining bolt 170 according to the sixth embodiment is inserted into the bolt insertion hole 227 from a side of the mounting portion 200I. The axial portion 171 of the retaining bolt 170 is then screwed into the engaging internal thread portion 168 of the tie bar 100E through the external thread 172. Here, fastening of the head 173 of the retaining bolt 170 is performed within tolerance where the tie bar 100E is not slipped off from the mounting portion 200I and rotatable within the retaining concave portion 155. As discussed, in a condition where the tie bar 100E is supported by the mounting portion 200I, the tie bar 100E is abutted to the retaining surface portions 218a, 218b, 226 of the mounting portion 200I. Accordingly, the installation hole 220a of the mounting portion 200I can be coincident with the internal thread portion 162a of the tie bar 100E while the installation hole 220b of the mounting portion 200I can be also coincident with the internal thread portion 162b of the tie bar 100E.

When the caliper 13 is installed to a vehicle, as discussed hereinabove, in a condition where the tie bar 100E is supported by the mounting portion 200I of the knuckle 14I in advance, the surface portion 193a of the mounting portion 82I of the caliper 13 on a side of the disk 11 is abutted to the abutting surface portion 211a of the mounting portion 200I of the knuckle 14I on a side opposite to the tie bar 100E. When abutted, the head 173 of the retaining bolt 170 can be adjusted through the escape groove 228. Further, the surface portion 193b of the mounting portion 82I a side of the disk 11 is also abutted to the abutting surface portion 211b of the mounting portion 200I of the knuckle 14I on a side opposite to the tie bar 100E. Then, by positionally adjusting installation hole 195a of the mounting portion 82I to the installation hole 220a of the knuckle 14I, the axial portion 115a of the fixing bolt 114a is inserted into the installation hole 195a from a side opposite to the disk 11 so as to insert the axial portion 115a of the fixing bolt 114a into the installation hole 220a of the knuckle 14I. Accordingly, the axial portion 115a of the fixing bolt 114a is screwed into the internal thread portion 162a of the adaptor portion 161a of the tie bar 100E through the external thread 116a. In the same manner, by positionally adjusting installation hole 195b of the mounting portion 82I to the installation hole 220b of the knuckle 14I, the axial portion 115b of the fixing bolt 114b is inserted into the installation hole 195b from a side opposite to the disk 11 so as to insert the axial portion 115b of the fixing bolt 114b into the installation hole 220b of the knuckle 14I. Accordingly, the axial portion 115b of the fixing bolt 114b is screwed into the internal thread portion 162b of the adaptor portion 161b of the tie bar 100E through the external thread 116b. Lastly, the head 117a of the fixing bolt 114a and the head 117b of the fixing bolt 114b are both fastened while the head 173 of the retaining bolt 170 is also fastened.

Accordingly, as the same with the eleventh embodiment, the mounting portion 82I of the caliper 13 and the knuckle 14I are both fastened by means of the tie bar 100E and two fixing bolts 114a, 114b.

In the twelfth embodiment as discussed hereinabove, since the tie bar 100E approximately the same with the eleventh embodiment is installed to the mounting portion 200I of the knuckle 14I, effects approximately the same with the eleventh embodiment can be obtained. Further, as regards the support of the tie bar 100E that is different from the eleventh embodiment to the mounting portion 200I, although the retaining bolt 170 becomes necessary, the retaining bolt 170 still can be screwed into the engaging internal thread portion 168 while the fixing bolts 114a, 114b are both loosely fitted into the adaptor portions 161a, 161b. Accordingly, since the tie bar 100E can be supported by the mounting portion 200I, it is easy to manage the length of the tie bar 100E and the length between the retaining wall portions 156a, 156b.

Further, since the tie bar 100E can be supported by the mounting portion 200I by means of the retaining portion 170, only the bolt insertion hole 227 is needed for the mounting portion 200I while only the engaging internal thread portion 168 is needed for the tie bar portion 163 of the tie bar 100E whereby cost can be reduced.

Still further, since the tie bar 100E can be supported by the mounting portion 200I by means of the retaining bolt 170 in addition to the fixing bolts 114a, 114b, the tie bar 100E has three connecting portions relative to the mounting portion 200I, whereby the rigidity of the tie bar 100E to the mounting portion 200I is improved so as to further reduce braking noises.

Here, although several embodiments of the present invention have been discussed hereinabove, these embodiments can be also applied to a floating disk brake where lining pads are not supported by a caliper but supported by a carrier. In this case, the above-discussed constructions applied to the mounting portion of the caliper should apply to a mounting portion of the carrier.

Further, in each of the above embodiments, the caliper has been explained as one where a pair of half bodies is connected with each other by a tie bolt; however, the embodiments are applicable to a mono-block disk brake where an inner half body and an outer half body are integrally formed.

Still further, in the embodiments, the tie bars have been discussed with a symmetrical formation, the present invention is not limited thereto, but the tie bars can be asymmetrically formed according to formations of calipers, knuckles, carriers, and the like.

Lastly, although the present invention has been illustrated and explained with respect to a specific exemplar thereof, the exemplar is not intended to limit the technical scope of the present invention, and variations in which parts of constituent members in the exemplar are substituted or eliminated or in which additional constituent members are provided may be naturally included in the technical scope of the present invention.

What is claimed is:

1. A disk brake, comprising:
a pad supporting member where at least a pair of lining pads is supported, and at least two first installation holes are provided at a mounting portion that is installed to a vehicle;
at least two second installation holes provided at a non-rotational portion of the vehicle; and
a fixing bolt installed into the first and second installation holes so as to fasten the mounting portion and the non-rotational portion, wherein
a reinforcement member is provided with at least two internal thread portions into which the fixing bolt is screwed, the reinforcement member being formed with materials different from the ones of the mounting portion and the non-rotational portion, and
the mounting portion and the non-rotational portion are fastened by means of the reinforcement member and the fixing bolt.

2. The disk brake according to claim 1, wherein the reinforcement member is molded into one of the pad supporting member and the non-rotational portion of the vehicle when the one of the pad supporting member and the non-rotational portion of the vehicle is molded.

3. The disk brake according to claim 1, wherein the reinforcement member is, prior to being fastened to the pad supporting member and the non-rotational portion by means of the fixing bolt, supported by the pad supporting member by making the internal thread portion and the first installation hole positionally coincident to each other, or supported by the non-rotational portion by making the internal thread portion and the second installation hole positionally coincident to each other.

4. The disk brake according to claim 3, wherein the reinforcement member is fastened to and supported by one of the pad supporting member and the non-rotational portion of the vehicle.

5. The disk brake according to claim 4, wherein the reinforcement member is supported by an elastic member that intervenes between the reinforcement member and the pad supporting member, or between the reinforcement member and the non-rotational portion of the vehicle.

6. The disk brake according to claim 3, wherein the reinforcement member is supported by an engagement member to one of the pad supporting member and the non-rotational portion of the vehicle.

7. The disk brake according to claim 6, wherein the reinforcement member is supported by a screw member to one of the pad supporting member and the non-rotational portion of the vehicle.

8. A disk brake, comprising:
a pad supporting member where at least a pair of lining pads is supported, at least two first installation holes are provided at a mounting portion that is installed to a vehicle, and at least two second installation holes are provided at a non-rotational portion of the vehicle wherein the mounting portion is fastened to the non-rotational portion by means of a fixing bolt that is screwed into the first and the second installation holes; and
a reinforcement member that: is provided at the mounting portion of the pad supporting member; has at least two internal thread portions into which the fixing bolt is screwed; and is formed by metal, Young's modulus of which is higher than the mounting portion of the pad supporting member,
wherein the reinforcement member is placed on a side opposite to the non-rotational portion and installed to the mounting portion in a condition that the first installation hole and the internal thread hole are positionally coincident to each other.

9. The disk brake according to claim 8, wherein the mounting portion is provided with a concave portion, the reinforcement member is provided with a projection portion so as to engage with the concave portion, and the projection portion is provided with the internal thread portion.

10. The disk brake according to claim 9, wherein two numbers of the projection portions are provided, and the reinforcement member is supported by the mounting portion as that internally opposed surfaces of the projection portions are fastened to the mounting portion.

11. The disk brake according to claim 9, wherein two numbers of the projection portions are provided, and the reinforcement member is supported by the mounting portion as that one of the projection portions is fitted to and fastened to the mounting portion.

12. The disk brake according to claim 9, wherein the projection portion is provided with an O-ring at an outer periphery thereof, and the reinforcement member is supported by the mounting portion as that the O-ring intervenes between the projection portion and the concave portion.

13. The disk brake according to claim 8, wherein the reinforcement member has end portions in a longitudinal direction thereof, the reinforcement member being fastened to and supported by the mounting portion with the end portions.

14. The disk brake according to claim 8, wherein the reinforcement member is loosely fitted to the pad supporting member and supported by an engagement member.

15. The disk brake according to claim 14, wherein the engagement member is a screw member, and the reinforcement member is provided with an engaging internal thread portion.

16. A disk brake, comprising:
an aluminum alloy caliper, the caliper being integrally composed of: a pad supporting member where at least a pair of lining pads is supported so as to sandwich a disk, and at least two first installation holes are provided at a mounting portion that is installed to a vehicle; and a cylinder member where pistons are provided facing to each other so as to press each of the lining pads, the caliper being installed to the vehicle by means of a fixing bolt installed into the first installation hole as well as at least two second installation holes provided at a non-rotational portion of the vehicle;
a metal-made reinforcement member that is formed with Young's modulus higher than the mounting portion of the caliper and that is composed of: at least two adaptor portions provided on a side opposite to the non-rotational portion, the adaptor portions being fastened to the mounting portion of the pad supporting member and being provided with an internal thread portion into which the fixing bolt is screwed; and a tie bar portion that connects each of the adaptor portions,
wherein the reinforcement member is fastened to and supported by the mounting portion of the pad supporting member by means of the adaptor portions.

17. The disk brake according to claim 16, wherein the reinforcement member is supported by the mounting portion of the pad supporting member by press-fitting one of the at least two adaptor portions into the mounting portion.

18. The disk brake according to claim 17, wherein the reinforcement member is supported by the mounting portion of the pad supporting member in such a manner that one of the at least two adaptor portions is press-fitted into the mounting portion while the other adaptor portion is loosely fitted into the mounting portion.

19. The disk brake according to claim 16, wherein the at least two adaptor portions are provided with O-rings at the outer peripheries thereof, and the reinforcement member is supported by the mounting portion of the pad supporting member through deformation of the O-rings in a radius direction.

20. The disk brake according to claim 16, wherein the tie bar portion is provided with an engaging internal thread portion, the at least two adaptor portions are both loosely fitted, and the reinforcement member is supported by the mounting portion of the pad supporting member by means of a screw member that is screwed into the engaging internal thread portion.
